(19) United States
(12) Patent Application Publication
(10) Pub. No.: US 2025/0119191 A1
(43) Pub. Date: Apr. 10, 2025

(54) METHODS FOR ENABLING DYNAMIC PUNCTURING IN WLAN SYSTEMS

(71) Applicant: INTERDIGITAL PATENT HOLDINGS, INC., Wilmington, DE (US)

(72) Inventors: Hanqing Lou, Syosset, NY (US); Zinan Lin, Basking Ridge, NJ (US); Mahmoud Saad, Montreal, CA (US); Xiaofei Wang, North Caldwell, NJ (US); Rui Yang, Greenlawn, NY (US)

(73) Assignee: INTERDIGITAL PATENT HOLDINGS, INC., Wilmington, DE (US)

(21) Appl. No.: 18/834,857

(22) PCT Filed: Feb. 6, 2023
(86) PCT No.: PCT/US2023/012389

§ 371 Date: Jul. 31, 2024

Related U.S. Application Data
(60) Provisional application No. 63/307,141, filed on Feb. 6, 2022.
(60) Provisional application No. 63/312,596, filed on Feb. 22, 2022.
(60) Provisional application No. 63/404,763, filed on Sep. 8, 2022.

(51) Int. Cl. H04B 7/06; H04L 1/00; H04L 5/00

(52) U.S. Cl. CPC H04B 7/0617; H04L 1/0069; H04L 5/0007

(57) ABSTRACT

Dynamic puncturing in a wireless local area network (WLAN) supporting 320 MHz bandwidths is disclosed. In one example, a method includes a first station (STA1) transmitting a null data packet announcement (NDPA) frame including an indicator of an orthogonal frequency division multiple access (OFDMA) subchannel puncturing over a wireless medium and subsequently transmitting a null data packet (NDP) having a U-SIG field specifying an OFDMA puncturing pattern. The NDPA may indicate that the subsequent NDP, which preferably occupies an 80 MHz channel, includes the OFDMA puncturing pattern in its U-SIG field. The method may further include transmitting a beamforming report poll (BFRP) soliciting measurement by the receiving station (STA2) on active resources, e.g., subchannels which have not been punctured. STA2 may transmit a beamforming report (BFR) in response to the BFRP, the BFR including measurements of active resources excluding subchannels inactive due to static OFDMA puncturing or dynamic OFDMA puncturing.

### CROSS-REFERENCE TO RELATED APPLICATIONS

This application claims the benefit of U.S. Provisional Application No. 63/307,141, filed Feb. 6, 2022, U.S. Provisional Application No. 63/312,596, filed Feb. 22, 2022, Provisional Application No. 63/404,763, filed Sep. 8, 2022, the contents of each are incorporated herein by reference.

### BACKGROUND

A WLAN in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

Using the 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining eight contiguous 20 MHz channels, or by combining two non-contiguous 80 MHz channels, this may also be referred to as an 80+80 configuration. For the 80+80 configuration, the data, after channel encoding, is passed through a segment parser that divides it into two streams. IFFT, and time domain, processing may be performed on each stream separately. The streams are then mapped on to the two channels, and the data is transmitted. At the receiver, this mechanism is reversed, and the combined data is sent to the media access control (MAC) layer.

To improve spectral efficiency 802.11 ac has introduced the concept for downlink (DL) Multi-User MIMO (MU-MIMO) transmission to multiple STA's in the same symbol's time frame, e.g. during a downlink orthogonal frequency division multiplexing (OFDM) symbol. The potential for the use of downlink MU-MIMO is also currently considered for 802.11ah. It is important to note that since downlink MU-MIMO, as it is used in 802.11ac, uses the same symbol timing to multiple STA's interference of the waveform transmissions to multiple STA's is not an issue. However, all STA's involved in MU-MIMO transmission with the AP must use the same frequency channel or band. This limits the operating bandwidth to the smallest channel bandwidth that is supported by the STA's which are included in the MU-MIMO transmission with the AP.

### SUMMARY

Methods and apparatus to perform dynamic puncturing is disclosed. A method performed by a station (STA) to determine if dynamic puncturing exists may compromise: receiving a transmission; comparing, in the transmission, a punctured channel pattern indicated by an INACTIVE_SUBCHANNELS parameter passed from a PHY with the punctured channel pattern indicated in a Disabled Subchannel Bitmap field of an extremely high throughput (EHT) Operation element within the sounding bandwidth (BW); wherein, on a condition that a number of punctured subchannels indicated by a RXVECTOR parameter INACATIVE_SUBCHANNELS is larger than a number of punctured subchannels indicated in the Disabled Subchannel Bitmap field of the EHT Operation element, dynamic puncturing exists in the transmission.

A method performed by a station (STA) to enable dynamic puncturing may compromise detecting extra tones (subcarriers) in an OFDM symbol, wherein the extra tones are used for one or more of the following: to indicate whether dynamic puncturing is performed in a physical layer protocol data unit (PPDU); to indicate whether preamble puncturing is performed in the PPDU; and/or to indicate whether preamble puncturing is performed in another 20 MHz subchannel.

In accordance with a first aspect of the embodiments, a method of a first station (STA1) communicating in a wireless network may include: transmitting a null data packet announcement (NDPA) frame over a wireless medium, the NDPA frame including an indicator of an orthogonal frequency division multiple access (OFDMA) subchannel puncturing of a subsequent null data packet (NDP); transmitting the null data packet (NDP) occupying at least one 80 MHz channel, the NDP having a U-SIG field specifying an OFDMA puncturing pattern; transmitting a beamforming report poll (BFRP) soliciting measurement on active resources; and receiving a beamforming report (BFR) from a second station (STA2) in response to the BFRP, the beamforming report including measurements of active resources excluding inactive subchannels of the OFDMA puncturing pattern.

The method may further define that measurements of active resources excludes inactive subchannels including static OFDMA puncturing identified from a Disabled Subchannel Bitmap and dynamic OFDMA puncturing identified from one or more U-SIG fields. Indicia of inactive subchannels may be present in a partial bandwidth (BW) subfield of the NDPA frame and/or dynamic OFDMA puncturing is based on one or more of: the OFDMA puncturing pattern in the NDP U-SIG field and STA2 channel sensing. Further, the beamforming report may include an identifier of dynamic OFDMA puncturing.

In one example, the NDPA frame comprises a duplicate non-high throughput (Non-HT) physical protocol data unit (PPDU) having a partial BW subfield containing the indicator of the OFDMA subchannel puncturing with 40 MHz minimum subchannel resolution, and the NDP comprises an extremely high throughput (EHT) PPDU including the U-SIG having the OFDMA puncturing pattern with 20 MHz minimum subchannel resolution. The indicator of OFDMA subchannel puncturing may include an OFDMA puncturing mode signal.

In accordance with other aspects of the embodiments, a wireless transmit and receive unit (WTRU) may include: a processor; and a transmitter configured by the processor to transmit, in a transmit opportunity (TXOP), a null data packet announcement (NDPA) frame and subsequently, a null data packet (NDP) frame occupying an 80 MHz or higher subchannel bandwidth The NDPA frame indicates that the subsequent NDP frame utilizes an orthogonal frequency division multiple access (OFDMA) puncturing pattern identified in a signaling field of the NDP frame.

The OFDMA puncturing pattern signals which subchannels are punctured in the NDP frame and the transmitter is further configured by the processor to transmit a beamforming report poll (BFRP) in the TXOP.

The WTRU may further include a receiver configured by the processor to receive a beamforming report (BFR) in the TXOP, in response to the BFRP, send from a separate beamformee. The BFR including measurements of active subchannels and signaling indicating inactive subchannels comprising static OFDMA punctured subchannels and dynamic OFDMA punctured subchannels. The static OFDMA punctured subchannels are subchannels identified by signaling in a Partial BW subfield of the NDPA frame and dynamic OFDMA punctured subchannels are subchannels identified from a U-SIG field of the NDP frame.

In one example, the NDPA frame comprises a duplicated non-high throughput (Non-HT) PPDU signaling OFDMA puncturing in the subsequent NDP frame, and the NDP frame comprises an extremely high throughput (EHT) PPDU and the signaling field comprises a U-SIG field. The NDPA frame includes a Partial BW field identifying punctured subchannels and an OFDMA puncture mode field signaling to a remote receiver to check the U-SIG field of the NDP for additional punctured subchannels having a different resolution.

A further aspect of the embodiments include a wireless transmit and receive unit (WTRU) including: a processor; a transmitter configured by the processor to transmit a beamforming report (BFR) comprising measurements of active subchannels and indication of inactive subchannels due to static and dynamic puncturing of orthogonal frequency division multiple access (OFDMA) subchannels; a receiver configured by the processor, to receive a null data packet announcement (NDPA) frame, and a null data packet (NDP) frame occupying at least an 80 MHz subchannel, wherein the inactive subchannels indicated in the BFR comprise a combination of punctured OFDMA subchannels identified in a partial bandwidth (BW) subfield of the NDPA frame and an OFDMA puncturing pattern identified in a U-SIG field of the NDP frame.

The beamforming report, e.g., the PPDU carrying it or MAC fields within it, signals dynamic puncturing due to identifications from the U-SIG field of the NDP frame. In one example, the NDPA frame comprises a duplicate non-high throughput (Non-HT) physical protocol data unit (PPDU) and wherein the NDP frame comprises an extremely high throughput (EHT) PPDU. OFDMA subchannels may further be dynamically punctured based on WTRU channel sensing. In a 320 MHz system bandwidth, punctured OFDMA subchannels identified in the NDPA frame may have a minimum resolution of 40 MHz subchannels and the punctured OFDMA subchannels identified from the NDP frame may have a minimum resolution of 20 MHz subchannels. In one example, the OFDMA puncturing pattern of the U-SIG field comprises a four bit indicator of the 80 MHz channel, each bit having a 20 MHz subchannel indexing. Further, the indication of inactive subchannels due to static and dynamic puncturing of OFDMA subchannels comprises an INACTIVE_SUBCHANNELS parameter of a TXVECTOR. In preferred embodiments, the transmitter and receiver are configured to communicate using 802.11 protocols with 320 MHz bandwidth support.

### BRIEF DESCRIPTION OF THE DRAWINGS

A more detailed understanding will follow from the description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an exemplary diagram of a trigger frame (TF) for A-PPDU;

FIG. 3 is an exemplary diagram of a Common Information field of Trigger Frame extremely high throughput (EHT) variant;

FIG. 4 is an exemplary diagram of a Special User Information field of Trigger Frame;

FIG. 5 is an exemplary diagram of a EHT variant User Information field;

FIG. 6 is an exemplary diagram of a valid combinations of B54 and B55 in the Common Info field, B39 in the User Info field, and solicited trigger-based (TB) PPDU format;

FIG. 7 is an exemplary diagram of an EHT operation element format;

FIG. 8 is an exemplary diagram of EHT Operation Information subfields;

FIG. 9 is an exemplary diagram of a multi-user request-to-send (MU-RTS) transmission sharing (TXS) Trigger Frame with transmission opportunity (TXOP) Sharing Mode subfield value=1, soliciting uplink (UL) PPDU specified in 802.11be;

FIG. 10 is an exemplary diagram of a MU-RTS TXS Trigger Frame with TXOP Sharing Mode subfield value=2 as specified in 802.11be;

FIG. 11 is an exemplary diagram of a null data packet (NDP) frame occupied subchannels;

FIG. 12 is an exemplary diagram of an EHT operating in a 320 Mhz channel;

FIG. 13 is an exemplary diagram of cascade signaling of various embodiments;

FIG. 14 illustrates an exemplary procedure of dynamic puncturing when the Puncturing Information is carried in the non-HT duplicate PPDU;

FIG. 15 illustrates an exemplary procedure of dynamic puncturing when the Dynamic Puncturing Information is carried in MAC header of a MAC frame;

FIG. 16 illustrates an exemplary non-TB sounding procedure with dynamic puncturing;

FIG. 17 is an exemplary diagram of a MU-RTS TXS Trigger frame with TXOP Sharing Mode subfield value=2 and dynamic puncturing occurs in the frame exchange initiated by non-AP STA1;

FIG. 18 is an exemplary diagram of a sounding procedure using OFDMA puncturing patterns of an embodiment;

FIG. 19 is an exemplary diagram of an EHT sounding NDP format of an embodiment; and

FIG. 20 is an exemplary diagram of an enhanced EHT Operation element format of an embodiment.

### DETAILED DESCRIPTION

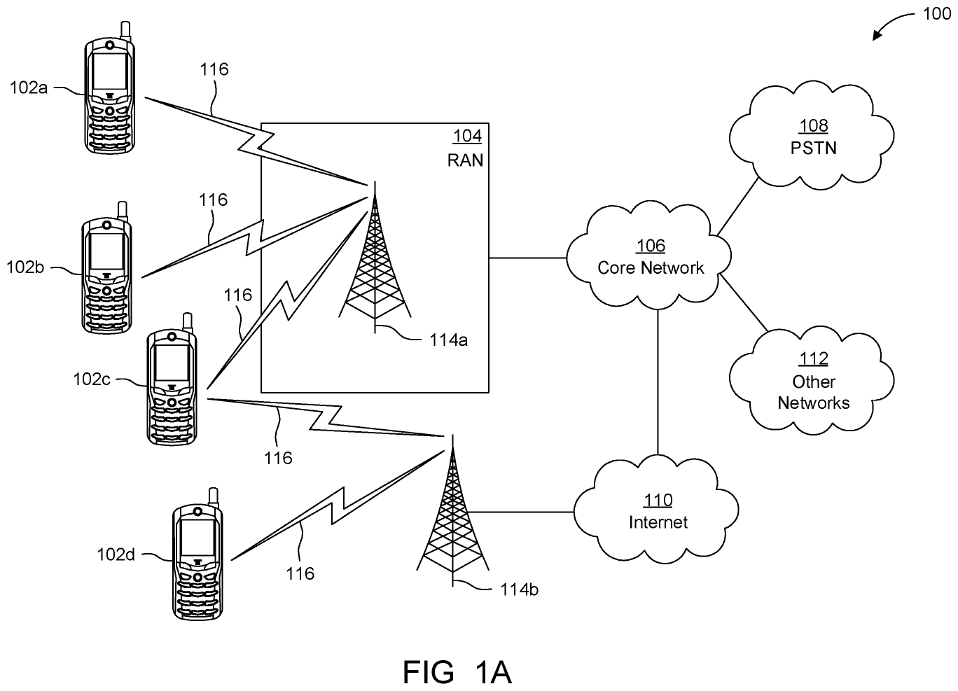

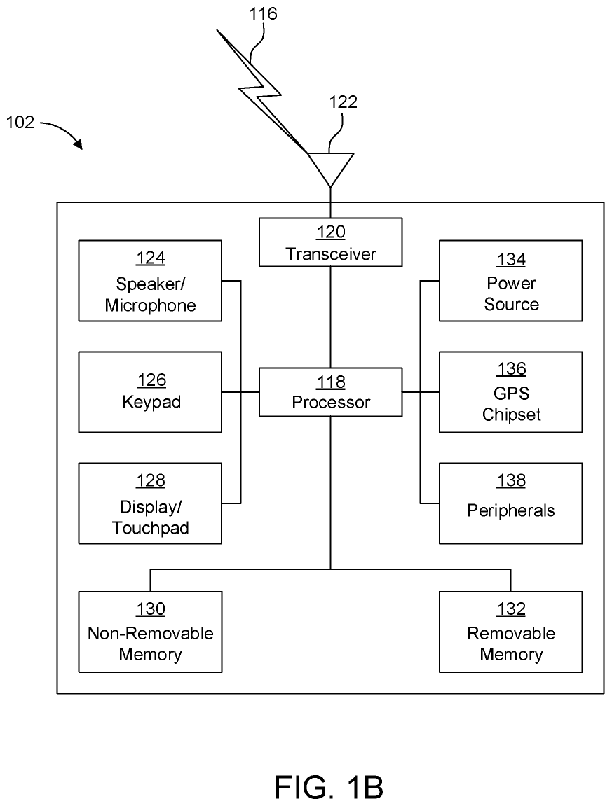

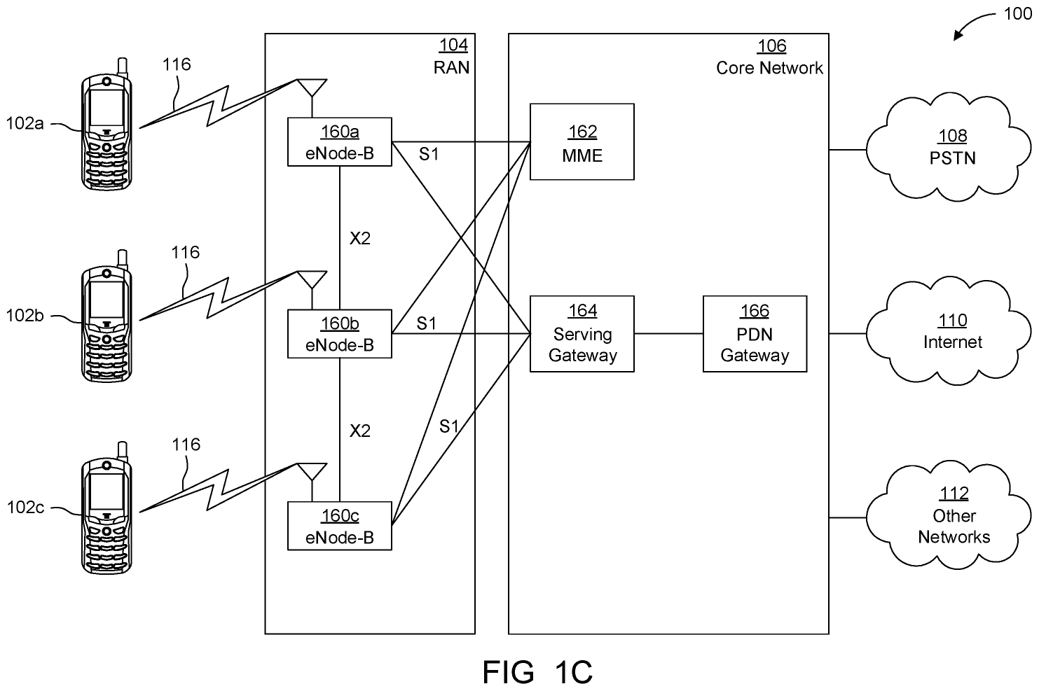

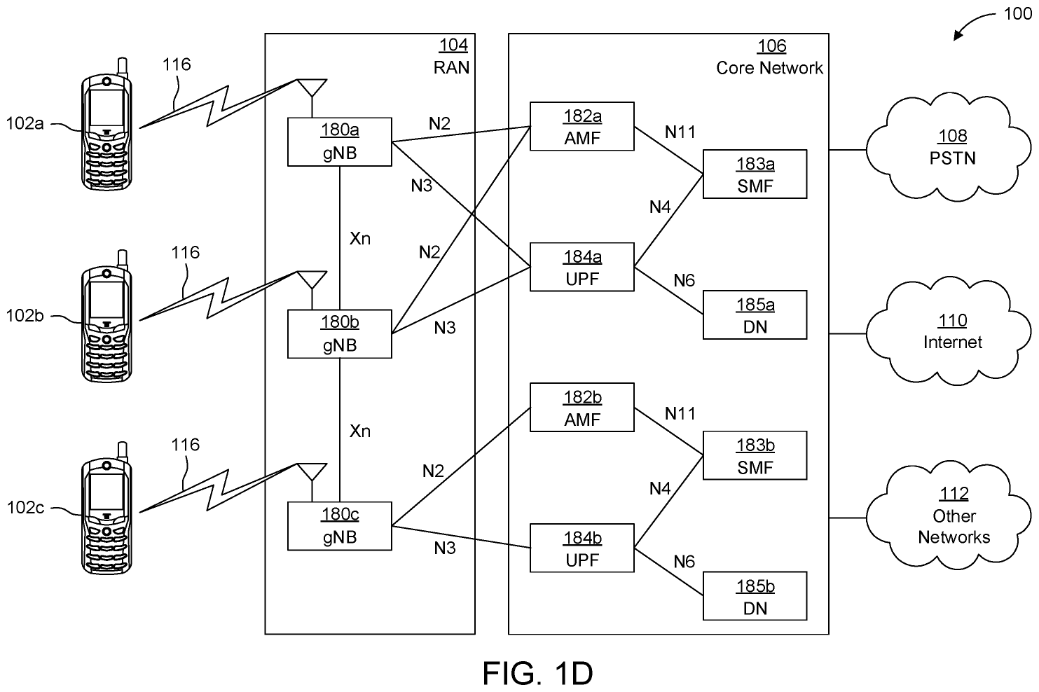

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though itwill be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) PacketAccess (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11 e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The IEEE 802.11 Extremely High Throughput (EHT) Study Group was formed in September 2018. EHT is considered as the next major revision to IEEE 802.11 standards following 802.1 lax, which is currently in the Working Group Letter Ballot Stage. EHT is formed to explore the possibility to further increase peak throughput and improve efficiency of the IEEE 802.11 networks. Following the EHT Study Group, the 802.11be Task Group was established to provide for 802.11 EHT specifications. The primary use cases and applications addressed include high throughput and low latency applications such as: (1) Video-over-WLAN; (2) Augmented Reality (AR); and (3) Virtual Reality (VR).

A list of features that has been discussed in the EHT SG and 802.11be to achieve the target of increased peak throughput and improved efficiency include: (1) Multi-AP; (2) Multi-Band/multi-link; (3) 320 MHz bandwidth; (4) 16-Spatial Streams; (5) HARQ; (6) AP Coordination; and (7) New designs for 6 GHz channel access.

EHT supports greater bandwidth (BW), Multiple resource unit (RU) allocation, enhanced modulation and coding scheme (MCS) and a greater number of spatial streams. A Trigger Frame (TF) design needs to be modified to signal the allocation from the AP for these enhanced features and to signal the new fields of U-SIG of the trigger-based physical protocol data unit (TB-PPDU).

EHT may define frequency domain aggregation of aggregated PPDUs (A-PPDU). An aggregated PPDU consists of multiple PPDUs, where: (1) The PPDU format combination limits to EHT and HE are defined; (2) Other combinations may be determined; (3) For the PPDU using HE format, the PPDU BW is yet to be determined; (4) The number of PPDUs is to be determined; and (5) A-PPDU will be a feature in future releases.

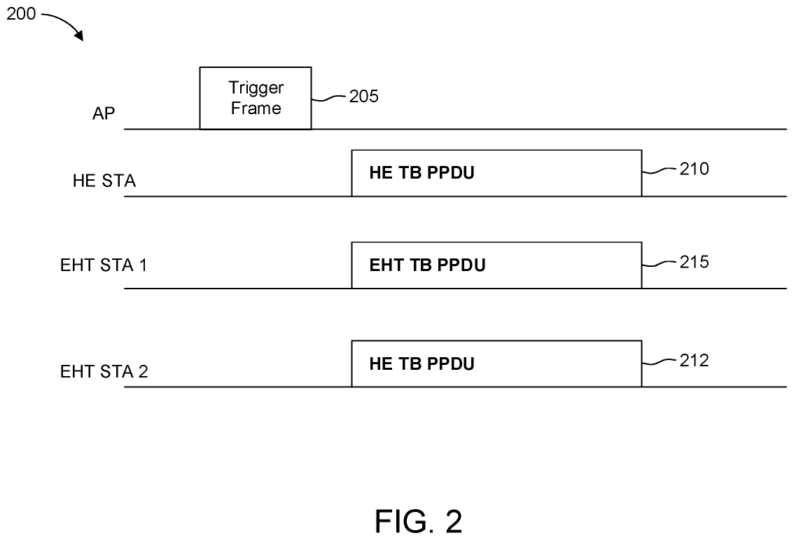

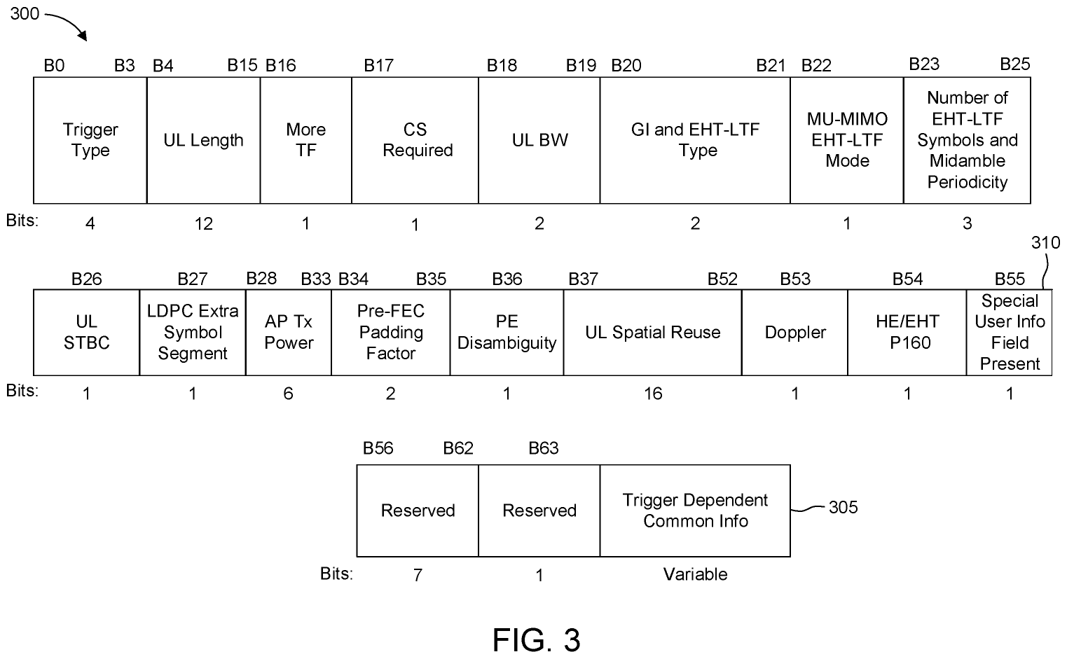

The A-PPDU in UL from multiple STAs supporting different amendments may require a backward compatible Trigger Frame 205, as shown in example timing diagram 200 of FIG. 2. In this embodiment, the AP may operate on a wideband channel, e.g., 320 MHz channel. The HE TB PPDU 210, 212 from HE STA and EHT STA-2 may be transmitted on the primary 160 MHz subchannel and EHT TB PPDU 215 from EHT STA-1 may be transmitted on the secondary 160 MHz subchannel. EHT Trigger Frames may use an 802.11ax trigger frame as a baseline. The EHT variant of the Common Info field is shown at B54 and B55 in example frame format 300 in FIG. 3. A Special User Info field and its indicator 310 is optionally present for EHT variant Trigger Frame 300.

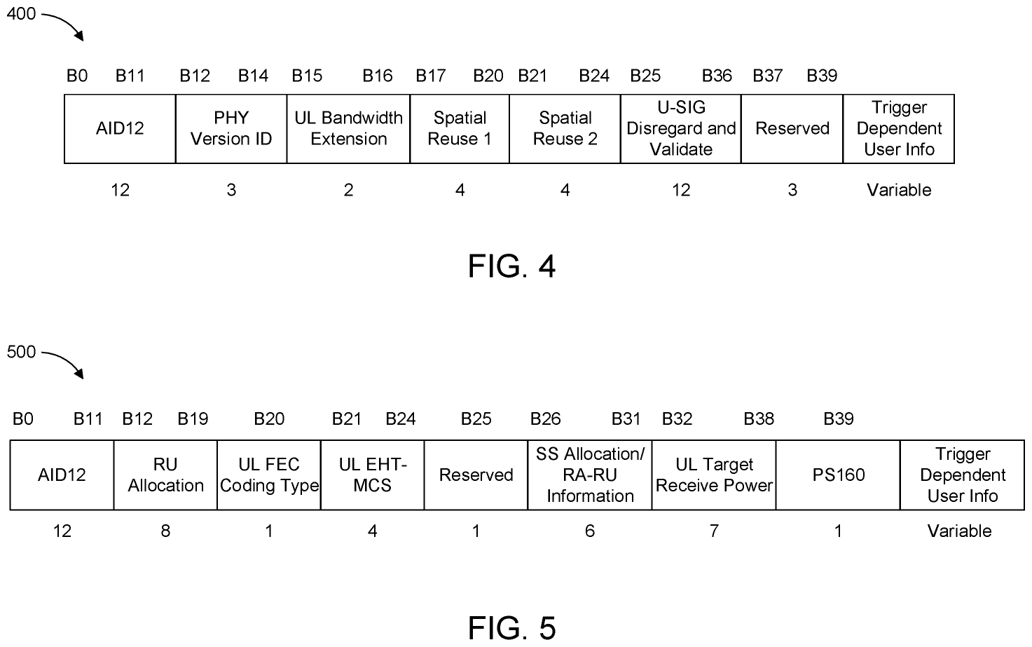

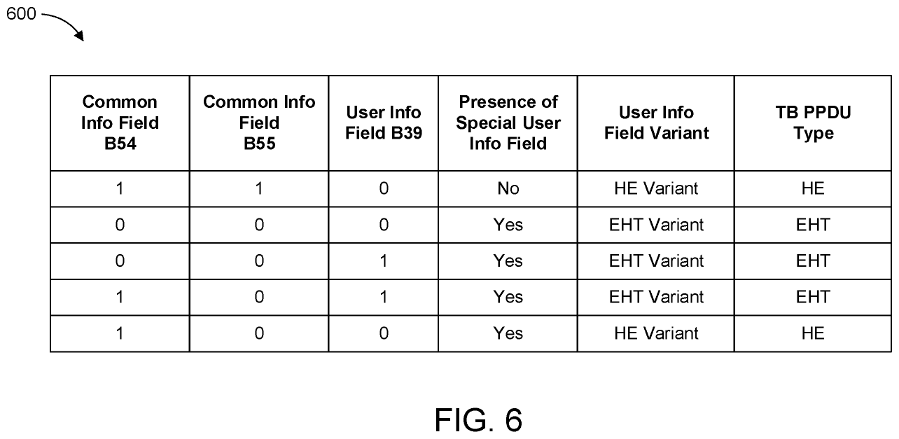

FIG. 4 illustrates an exemplary Special User Info field 400. FIG. 5 illustrates an exemplary EHT variant User Info Field 500. FIG. 6 illustrates a matrix 600 valid combinations of several bits from FIGS. 3-4 and a corresponding TB PPDU format solicited by Trigger Frame 300.

Preamble puncturing was introduced in 802.11 ax to allow a STA to transmit on certain subchannels but not the entire bandwidth. In other words, the preamble puncturing transmission of a PPDU may have no data signal present in one or more punctured subchannels within the PPDU bandwidth. In 802.11be, two types of preamble puncturing schemes were adopted, static puncturing and dynamic puncturing.

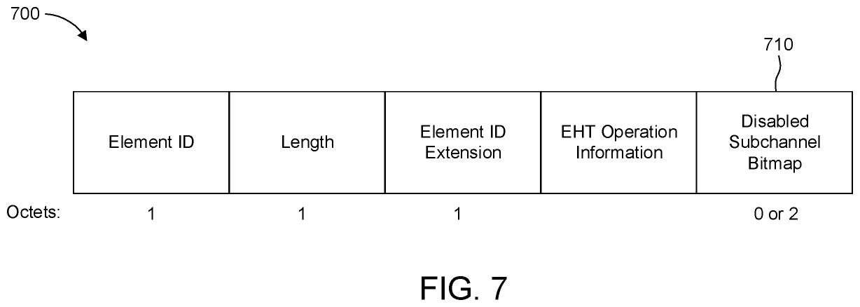

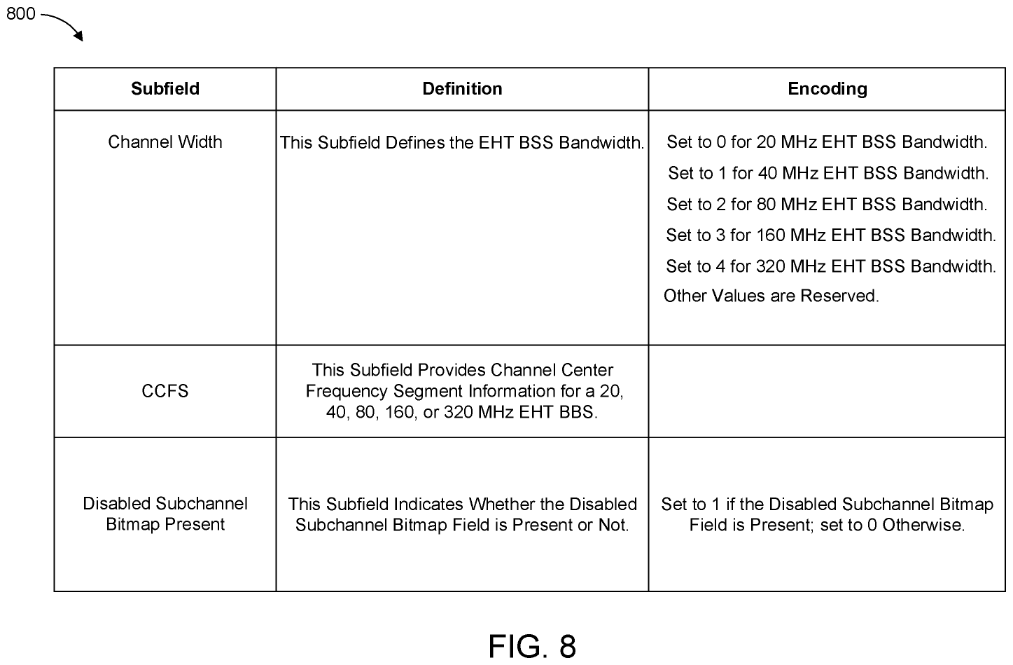

With static puncturing, one or more subchannels may be punctured for one or more Beacon intervals. An AP may add the Disabled Subchannel Bitmap field in the EHT Operation element to indicate one or more subchannels are disabled. STAs may set the TXVECTOR parameter INACTIVE_SUBCHANNELS of an HE, EHT, or non-HT duplicate PPDU based on the value indicated in the most recently exchanged Disabled Subchannel Bitmap field in the EHT Operation element for that BSS. STAs may not transmit anything on the disabled subchannels. FIG. 7 illustrates an example EHT Operation element 700 including an EHT Operation Information field. FIG. 8 illustrates a format of an EHT Operation Information field 800 describing elements and handling of exemplary EHT Operation Information subfields.

Referring to FIG. 7, if present, Disabled Subchannel Bitmap 710 is 2-Octets long. However, the valid puncturing pattern is defined in Table 1 below.

TABLE 1
Valid Puncturing Pattern in 802.11be

| | | Puncturing | |
|---|---|---|---|
| PPDU | | pattern (RU or | Field |
| Bandwidth | Cases | MRU Index) | Value |
| 20 MHz | No puncturing | [1 1 1 1] | 0 |
| | | (242-tone RU 1) | |
| 40 MHz | No puncturing | [1 1 1 1] | 0 |
| | | (484-tone RU 1) | |
| 80 MHz | No puncturing | [1 1 1 1] | 0 |
| | | (996-tone RU 1) | |
| | 20 MHz puncturing | [x 1 1 1] | 1 |
| | | (484 + 242-tone MRU 1) | |
| | | [1 x 1 1] | 2 |
| | | (484 + 242-tone MRU 2) | |
| | | [1 1 x 1] | 3 |
| | | (484 + 242-tone MRU 3) | |
| | | [1 1 1 x] | 4 |
| | | (484 + 242-tone MRU 4) | |
| 160 MHz | No puncturing | [1 1 1 1 1 1 1 1] | 0 |
| | | (2 [symbol] 996-tone RU 1) | |
| | 20 MHz puncturing | [x 1 1 1 1 1 1 1] | 1 |
| | | (996 + 484 + | |
| | | 242-tone MRU 1) | |
| | | [1 x 1 1 1 1 1 1] | 2 |
| | | (996 + 484 + | |
| | | 242-tone MRU 2) | |
| | | [1 1 x 1 1 1 1 1] | 3 |
| | | (996 + 484 + | |
| | | 242-tone MRU 3) | |
| | | [1 1 1 x 1 1 1 1] | 4 |
| | | (996 + 484 + | |
| | | 242-tone MRU 4) | |
| | | [1 1 1 1 x 1 1 1] | 5 |
| | | (996 + 484 + | |
| | | 242-tone MRU 5) | |
| | | [1 1 1 1 1 x 1 1] | 6 |
| | | (996 + 484 + | |
| | | 242-tone MRU 6) | |
| | | [1 1 1 1 1 1 x 1] | 7 |
| | | (996 + 484 + | |
| | | 242-tone MRU 7) | |
| | | [1 1 1 1 1 1 1 x] | 8 |
| | | (996 + 484 + | |
| | | 242-tone MRU 8) | |
| | 40 MHz puncturing | [x x 1 1 1 1 1 1] | 9 |
| | | (996 + | |
| | | 484-tone MRU 1) | |
| | | [1 1 x x 1 1 1 1] | 10 |
| | | (996 + 484- | |
| | | tone MRU 2) | |
| | | [1 1 1 1 x x 1 1] | 11 |
| | | (996 + 484- | |
| | | tone MRU 3) | |
| | | [1 1 1 1 1 1 x x] | 12 |
| | | (996 + 484- | |
| | | tone MRU 4) | |
| 320 MHz | No puncturing | [1 1 1 1 1 1 1 1] | 0 |
| | | (4 [symbol] 996-tone RU 1) | |
| | 40 MHz puncturing | [x 1 1 1 1 1 1 1] | 1 |
| | | (3 [symbol] 996 + | |
| | | 484-tone MRU 1) | |
| | | [1 x 1 1 1 1 1 1] | 2 |
| | | (3 [symbol] 996 + | |
| | | 484-tone MRU 2) | |
| | | [1 1 x 1 1 1 1 1] | 3 |
| | | (3 [symbol] 996 + 484- | |
| | | tone MRU 3) | |
| | | [1 1 1 x 1 1 1 1] | 4 |
| | | (3 [symbol] 996 + 484- | |
| | | tone MRU 4) | |
| | | [1 1 1 1 x 1 1 1] | 5 |
| | | (3 [symbol] 996 + | |
| | | 484-tone MRU 5) | |
| | | [1 1 1 1 1 x 1 1] | 6 |
| | | (3 [symbol] 996 + | |
| | | 484-tone MRU 6) | |
| | | [1 1 1 1 1 1 x 1] | 7 |
| | | (3 [symbol] 996 + | |
| | | 484-tone MRU 7) | |
| | | [1 1 1 1 1 1 1 x] | 8 |
| | | (3 [symbol] 996 + | |
| | | 484-tone MRU 8) | |
| | 80 MHz puncturing | [x x 1 1 1 1 1 1] | 9 |
| | | (3 [symbol] 996-tone MRU 1) | |
| | | [1 1 x x 1 1 1 1] | 10 |
| | | (3 [symbol] 996-tone MRU 2) | |
| | | [1 1 1 1 x x 1 1] | 11 |
| | | (3 [symbol] 996-tone MRU 3) | |
| | | [1 1 1 1 1 1 x x] | 12 |
| | | (3 [symbol] 996-tone MRU 4) | |
| | (#1616)Both 80 MHz | [x x x 1 1 1 1 1] | 13 |
| | and 40 MHz puncturing | (2 [symbol] 996 + | |
| | | 484-tone MRU 7) | |
| | | [x x 1 x 1 1 1 1] | 14 |
| | | (2 [symbol] 996 + | |
| | | 484-tone MRU 8) | |
| | | [x x 1 1 x 1 1 1] | 15 |
| | | (2 [symbol] 996 + | |
| | | 484-tone MRU 9) | |
| | | [x x 1 1 1 x 1 1] | 16 |
| | | (2 [symbol] 996 + | |
| | | 484-tone MRU 10) | |
| | | [x x 1 1 1 1 x 1] | 17 |
| | | (2 [symbol] 996 + | |
| | | 484-tone MRU 11) | |
| | | [x x 1 1 1 1 1 x] | 18 |
| | | (2 [symbol] 996 + | |
| | | 484-tone MRU 12) | |
| | | [x 1 1 1 1 1 x x] | 19 |
| | | (2 [symbol] 996 + | |
| | | 484-tone MRU 1) | |
| | | [1 x 1 1 1 1 x x] | 20 |
| | | (2 [symbol] 996 + | |
| | | 484-tone MRU 2) | |
| | | [1 1 x 1 1 1 x x] | 21 |
| | | (2 [symbol] 996 + | |
| | | 484-tone MRU 3) | |
| | | [1 1 1 x 1 1 x x] | 22 |
| | | (2 [symbol] 996 + | |
| | | 484-tone MRU 4) | |
| | | [1 1 1 1 x 1 x x] | 23 |
| | | (2 [symbol] 996 + | |
| | | 484-tone MRU 5) | |
| | | [1 1 1 11 x x x] | 24 |
| | | (2 [symbol] 996 + | |
| | | 484-tone MRU 6) | |

There are two puncturing patterns defined in 802.11be, non-OFDMA puncturing pattern as shown in Table 1 and OFDMA puncturing pattern. The OFDMA puncturing pattern contains more valid puncturing patterns than non-OFDMA puncturing patterns. The signaling of an OFDMA puncturing pattern is a 4-bit bitmap that indicates which 20 MHz subchannel is punctured in the relevant 80 MHz subchannel. The allowed puncturing bitmap pattern for a 80 MHz subchannel are 1111 (no puncturing), 0111, 1011, 1101, 1110, 0011, 1100 and 1001.

With dynamic puncturing, a STA may be allowed to puncture additional subchannels other than the ones indicated by Disabled Subchannel Bitmap field (e.g., 710; FIG. 7). The STA may determine to puncture new/additional subchannels on its own, for different reasons, for example it may be based on its physical or virtual channel sensing results. Dynamic puncturing may be explicitly signaled using the U-SIG field in EHT MU PPDU. The Punctured Channel Information field is carried in U-SIG field in EHT MU PPDU to indicate the punctured channels.

In one embodiment, the preamble puncturing resolution is 20 MHz for an EHT MU PPDU in OFDMA transmission and in non-OFDMA transmission for 80 MHz and 160 MHz bandwidth. Preamble puncturing resolution is 40 MHz for an EHT MU PPDU in non-OFDMA transmission for 320 MHz bandwidth.

Triggered TXOP sharing was introduced in 802.11be to allow an AP to allocate a time slot within an obtained TXOP to an associated STA. The STA may use the time slot to perform UL non-TB transmission(s) (Mode 1) or peer-to-peer (P2P) transmission(s) (Mode 2).

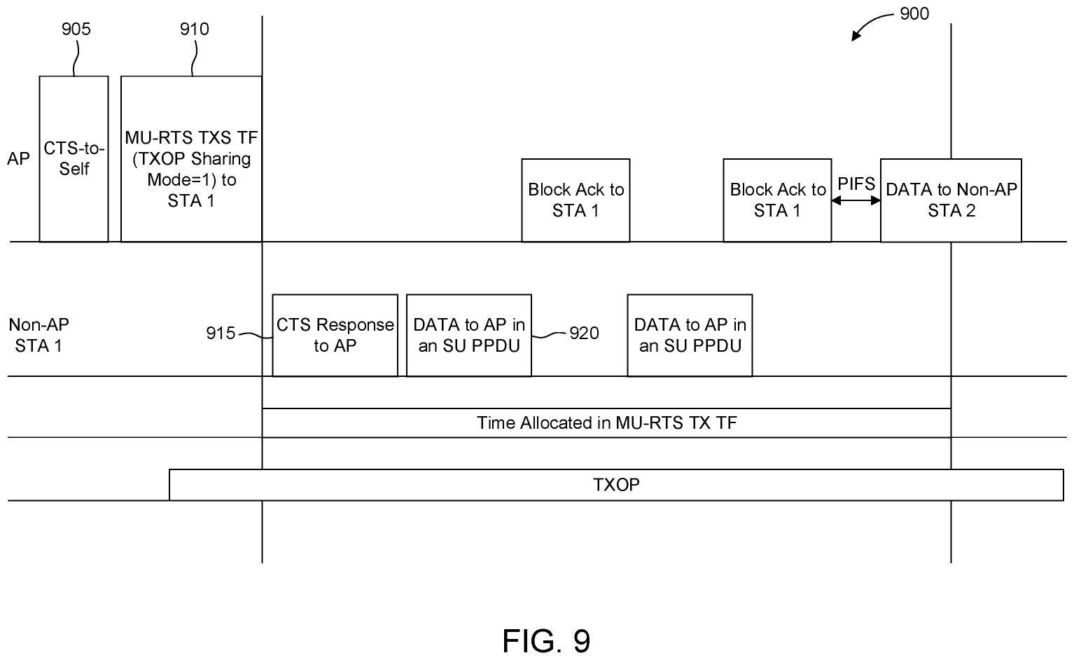

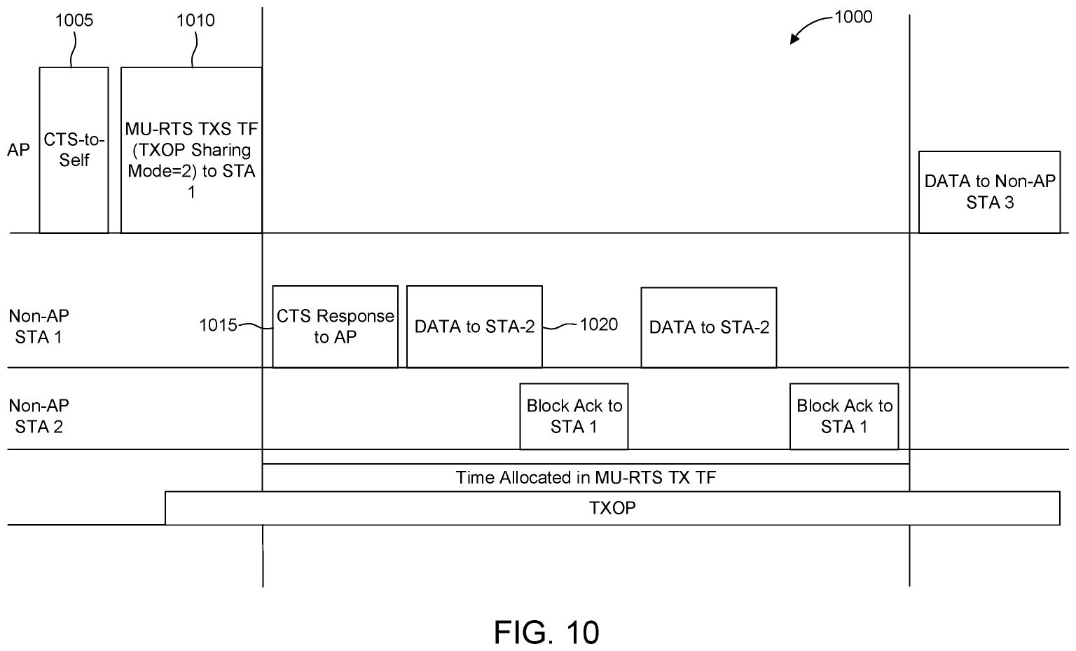

FIG. 9 is a sequence diagram showing a messaging procedure 900 of UL non-TB transmission(s) operating in Mode 1. FIG. 10 is a sequence diagram showing a messaging procedure 1000 of P2P transmissions operating in Mode 2. In both procedures 900 and 1000, an AP may acquire a TXOP and transmit a clear-to-send (CTS)-to-self frame 905, 1005. Then the AP may transmit a MU-RTS TXS Trigger frame 910, 1010 which allocates a time slot to non-AP STA1. In the MU-RTS TXS Trigger frame 910, 1010 the AP may indicate the TXOP sharing duration and TXOP sharing mode, e.g., mode-1 in FIG. 9 and mode-2 in FIG. 10. STA1 may respond a clear-to-send (CTS) frame 915, 1015 to the AP to confirm the time allocation. After that, STA1 may begin transmitting non-Trigger based PPDUs to either the AP (920; FIG. 9) or another non-AP STA (1020; FIG. 10) depending on the mode.

FIG. 9 shows an example of a MU-RTS TXS Trigger frame 910 with TXOP Sharing Mode subfield value=1 soliciting UL PPDU. FIG. 10 shows an example of MU-RTS TXS Trigger frame 1010 with TXOP Sharing Mode subfield value=2.

Currently, the TXVECTOR parameter INACTIVE_SUBCHANNELS. defined by IEEE 802.11be, communicates inactive subchannel information from MAC to PHY. A STA may set the TXVECTOR parameter. INACTIVE_SUBCHANNELS of an HE, EHT, or non-HT duplicate PPDU may be based on the value indicated in the most recently exchanged Disabled Subchannel Bitmap field in the EHT Operation element for that BSS. To use the frequency spectrum more efficiently and mitigate interference dynamically, additional subchannels other than that indicated in Disabled Subchannel Bitmap may be allowed to be punctured. However, the following problems need to be addressed to fully support dynamic puncturing: (1) signaling of punctured channel information is not defined in some cases so the receiver may not know all the punctured channels; and (2) mechanisms or procedures between PHY and MAC to pass dynamic punctured channel information are not yet specified.

In 802.11be, dynamic puncturing is not allowed in the non-TB based sounding procedure. However, there are cases that a beamformer may observe high interference in one or more subchannels besides the subchannels indicated in the Disabled Subchannel Bitmap. With the limitations of the current standard, the beamformer cannot perform non-TB based sounding even though it may acquire the channel, and thus the beamformer has to delay the sounding procedure.

TXOP sharing is introduced to allow a TXOP holder to share the TXOP with a STA for UL non-TB transmission or P2P transmission. Currently, dynamic puncturing is not allowed for the TXOP sharing transmission. If a STA is assigned a time slot for TXOP sharing transmission, and the STA observes one or more subchannels, which are not identified by the Disabled Subchannel Bitmap, are with high interference level or with network allocation vector (NAV) set, the STA may have to defer the entire transmission and thus may waste the assigned time slot.

As mentioned previously, TXOP sharing was introduced to allow a TXOP holder to share the TXOP with a STA for UL non-TB transmission or P2P transmission. The transmission during the shared time slot may be mostly from the shared STA to the AP or another non-AP STA. For an overlapping BSS (OBSS) STA, the interference level from the shared the time slot may be different from the OBSS AP. A spatial reuse procedure, which is not allowed currently, may be desired to improve the spectral efficiency.

In 320 MHz bandwidth, the resolution of the requested subchannels for partial bandwidth feedback in EHT is 40 MHz, and the resolution of the preamble puncturing as indicated by the Disabled Subchannel Bitmap field in the EHT Operation element is 40 MHz. However, in EHT OFDMA transmission, the resolution of subcarrier puncturing is 20 MHz. Since partial bandwidth feedback cannot be requested for a punctured subchannel in the current EHT specification, accordingly, feedback will not be requested for a 40 MHz if one of its two 20 MHz subchannels is punctured. A solution to allow for requesting partial bandwidth feedback for a 40 MHz with only one punctured subchannel of its two 20 MHz subchannels is desirable.

As used herein, “EHT+” designates next generations or specifications released beyond current 802.11be amendments for extremely high throughput WLAN as of the priority date of this disclosure. An EHT/EHT+STA may indicate its capability to support dynamic puncturing in the EHT/EHT+Capability element or other type of element/field/frame. For example, a newly defined subfield EHT/EHT+Dynamic Support may be carried in the EHT/EHT+MAC Capabilities Information field and/or the EHT/EHT+PHY Capabilities Information field in the EHT/EHT+Capabilities element.

An EHT/EHT+AP may indicate the support of dynamic puncturing in EHT/EHT+Operation element. For example, a newly defined subfield EHT/EHT+Dynamic Support may be carried in the EHT/EHT+Operation Parameters and/or the EHT/EHT+Operation Information field in the EHT/EHT+Operation element.

The following describes one exemplary embodiment using existing TXVECTOR/RXVECTOR Parameter INACTIVE_SUBCHANNELS to enable dynamic puncturing.

In one embodiment, the TXVECTOR parameter INACTIVE_SUBCHANNELS of an HE, EHT, non-HT duplicate PPDU or future type PPDU may include not only the punctured subchannels which are indicated in the most recently exchanged Disabled Subchannel Bitmap field in the EHT/EHT+Operation element, but also the dynamic punctured subchannels which are determined by the transmitting STA that supports dynamic puncturing. In other words, in an EHT/EHT+BSS set up by an EHT/EHT+AP that supports dynamic puncturing and has included the Disabled Subchannel Bitmap filed in the EHT/EHT+Operation element, an EHT/EHT+STA may set the TXVECTOR parameter INACTIVE_SUBCHANNELS of an HE, EHT, non-HT duplicate PPDU based on the value indicated in the most recently exchanged Disabled Subchannel Bitmap field in the EHT/EHT+Operation element for that BSS and the subchannels that are additionally punctured, before the transmission of this PPDU. If one 20 MHz subchannel is additionally/dynamically punctured in addition to those indicated in the subchannel in the Disabled Subchannel Bitmap field in the EHT/EHT+Operation element, the corresponding bit in the TXVECTOR parameter INACTIVE_SUBCHANNELS may be set=1. This additionally/dynamically punctured subchannel may be used by other PPDUs later if this subchannel becomes available.

In various embodiments, the TXVECTOR parameter INACTIVE_SUBCHANNELS of an HE, EHT, EHT+, and non-HT duplicate PPDU may be set based on one or more information sources. For example, the punctured channel information may be available in the RXVECTOR parameter INACTIVE_SUBCHANNELS through PPDU detection. The punctured channel information may be available in MAC header and/or MAC body through a MAC frame detection. The punctured channel information may also be available through channel sensing.

In various embodiments, a STA may set or update the TXVECTOR parameter INACTIVE_SUBCHANNELS to include punctured subchannels based on: (1) information carried in MAC header and/or MAC body; (2) information carried in the RXVECTOR parameter INACTIVE_SUBCHANNELS; (3) channel sensing results, for example, energy detection and/or virtual NAV setting; (4) the union of inactive subchannels indicated in MAC header and/or MAC body and the RXVECTOR parameter INACTIVE_SUBCHANNELS; (5) the union of inactive subchannels indicated in MAC header and/or MAC body and channel sensing results; (6) the union of inactive subchannels indicated in the RXVECTOR parameter INACTIVE_SUBCHANNELS and channel sensing results; (7) the intersection of inactive subchannels indicated in MAC header and/or MAC body and the RXVECTOR parameter INACTIVE_SUBCHANNELS; (8) the intersection of inactive subchannels indicated in MAC header and/or MAC body and channel sensing results; (9) the intersection of inactive subchannels indicated in the RXVECTOR parameter INACTIVE_SUBCHANNELS and channel sensing results; (10) the union of inactive subchannels indicated in MAC header and/or MAC body, the RXVECTOR parameter INACTIVE_SUBCHANNELS and channel sensing results; and/or (11) the intersection of inactive subchannels indicated in MAC header and/or MAC body, the RXVECTOR parameter INACTIVE_SUBCHANNELS and channel sensing results.

In some embodiments, a parameter DYNAMIC_INACTIVE_SUBCHANNELS (or other name) may be defined in TXVECTOR and/or RXVECTOR to indicate the dynamically, or additionally, punctured subchannels besides the inactive subchannels indicated in Disabled Subchannel Bitmap field. A STA which supports dynamic puncturing may not transmit on any 20 MHz subchannel that is punctured as indicated in the TXVECTOR parameter INACTIVE_SUBCHANNELS and DYNAMIC_INACTIVE SUBCHANNELS. The parameter DYNAMIC_INACTIVE_SUBCHANNELS may be included in the TXVECTOR of a non-HT duplicate PPDU or EHT PPDU or future type of PPDU.

A STA may set the TXVECTOR parameter DYNAMIC_INACTIVE_SUBCHANNELS based on channel sensing results, including energy detection and NAV setting. For example, a STA may observe some subchannels may be busy right before its transmission, the STA may set one or more busy subchannels which are not indicated in the TXVECTOR parameter INACTIVE_SUBCHANNELS inactive in the TXVECTOR parameter DYNAMIC_INACTIVE_SUBCHANNELS.

A STA may set the TXVECTOR parameter DYNAMIC_INACTIVE_SUBCHANNELS based on a received PPDU and/or MAC frame if it includes punctured subchannels which are not included in a current TXVECTOR parameter INACTIVE_SUBCHANNELS.

In one embodiment, an EHT beamformer may set the TXVECTOR parameter CH_BANDWIDTH or CH_BANDWIDTH_IN_NON_HT, the Partial BW Info subfield of the EHT NDP Announcement frame, depending on the operating channel width of the beamformee and/or the operating channel width of the beamformer, and/or the feedback RU/MRU. For example, in non-TB sounding sequences, the EHT beamformer may set TXVECTOR parameter CH_BANDWIDTH or CH_BANDWIDTH_IN_NON_HT to the minimum of the operating bandwidth of the beamformer and the operating bandwidth of the beamformee (also referred to in this disclosure as “BFee”) e.g., BW_{NDP}=min (OperatingBW_{Beamformee}, OperatingBW_{Beamformer}).

In TB sounding sequences, the EHT beamformer may set TXVECTOR parameter CH_BANDWIDTH or CH_BANDWIDTH_IN_NON_HT which depends on the operating channel width of the beamformee(s), e.g., BW_{NDP}=ƒ(OperatingBW_{Beamformee1}, Operating_{BWBeamformee2}, . . . , Operating_{BWBeamformeeN}, Requested RU/MRU size_{Beamformee1}, RequestedRU/MRU size_{Beamformee2}, . . . Requested RU/MRU size_{BeamformeeN}) where N is the total number of beamformees in one TB sounding sequence.

Table 2 below gives an exemplary null data packet announcement (NDPA) or NDP BW in one TB sounding sequence with two beamformees in multiple scenarios.

TABLE 2
Exemplary NDPA (or NDP) BW in one TB sounding Sequence with Two Beamformees

| OBSS | AP | Beamformee1 | Beamformee2 | Requested | NDPA BW (MHz), i.e., |
|---|---|---|---|---|---|
| operating | operating | operating | operating | RU/MRU | TXVECTOR parameter |
| BW | channel | channel width | channel width | size | CH_BANDWIDTH, |
| (MHz) | width (MHz) | (MHz) | (MHz) | (MHz) | C_BANDWIDTH_IN_NON_HT |
| 320 | 320 | 320 | 320 | 320 | 320 |
| 320 | 320 | 320 | 160 | 320 | 320 |
| | | | | (Beam- | |
| | | | | formee1); | |
| | | | | 160 | |
| | | | | (Beam- | |
| | | | | formee2) | |
| | | | | 160 | 160 |
| 320 | 320 | 160 | 160 | 160 | 160 |
| 320 | 160 | 320 | 320 | 160 | 160 |
| 320 | 160 | 160 | 160 | 160 | 160 |

In one embodiment of the TB sounding sequence, the occupied subchannel(s) indicated by the BW and Puncturing Channel Information fields in the U-SIG field of the NDP may be the same as the union of the requested subchannel(s) indicated in the Partial BW Info subfield of all STA Info fields indicated in the immediately preceding EHT NDP Announcement (NDPA) frame. The bandwidth of the EHT NDP Announcement frame and the EHT NDP frame may be the same. In the Partial BW Information, there are 9-bits, where the first bit represents the Resolution bit (e.g., 0 indicates a resolution of 20 MHz and 1 indicates a resolution of 40 MHz) and the following 8-bits are Feedback Bitmap. Each bit in the Feedback Bitmap subfield is set=1 if the feedback is requested on the corresponding resolution bandwidth. For example, there are two STAs which are triggered to send the feedback to the AP in the TB sounding sequence. The AP and both STAs have the 160 MHz operating bandwidth. Exemplary cases for this scenario are described below.

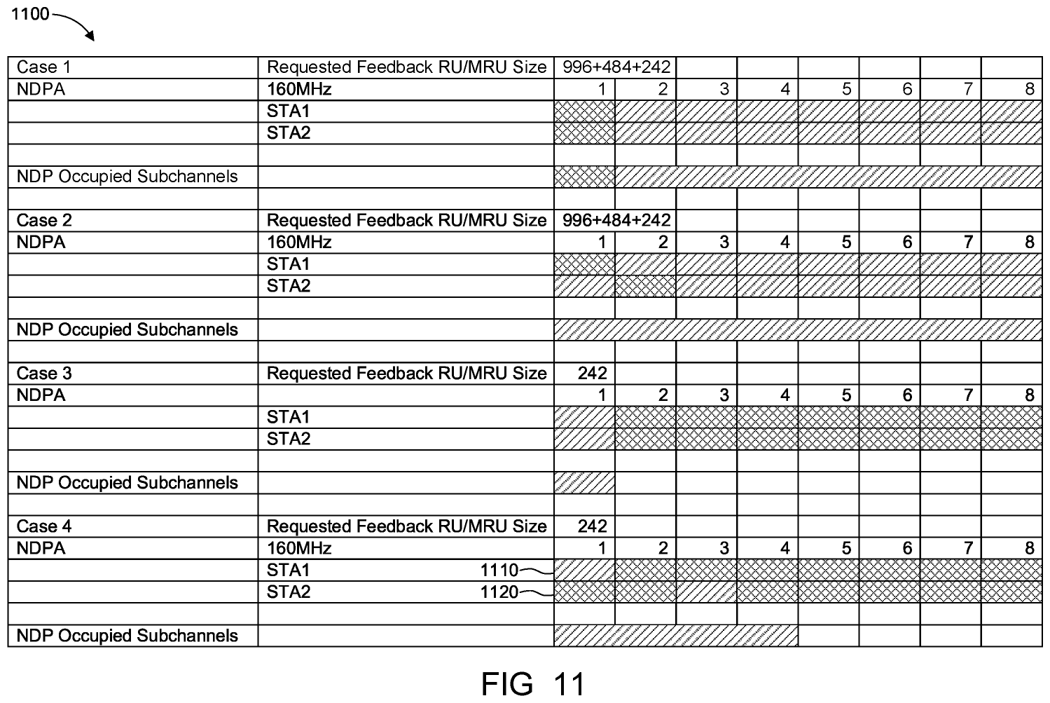

FIG. 11 is an exemplary matrix 1100 of NDP occupied subchannels in the case when there are two STAs and one AP and all of them support 160 MHz bandwidth operation. Lighter boxes 1110 represent requested subchannels indicated in the Partial BW Info subfield of the STA Infor field of NDP Announcement frame or the occupied subchannels indicated by the U-SIG field of NDP, while darker boxes 1120 represent the non-requested subchannels indicated in the Partial BW Info subfield of the STA Infor field of NDP Announcement frame.

In case #1 of FIG. 11, the Partial BW Information indicated by the two STAs may be [0 0 1 1 1 1 1 1 1], which indicates the feedback of the higher seven 20 MHz subchannels (e.g., 996+484+242-tone) is requested and the first lower 20 MHz subchannel is not requested. In this case, the first lower 20 MHz subchannel within 160 MHz NDP frame may be punctured. If the NDPA has occupied the 160 MHz, then NDP's bandwidth is 160 MHz.

In example case #2 of FIG. 11, the Partial BW Information indicated in the STA Infor field of STA1 may be [0 0 1 1 1 1 1 11], which indicates requested feedback of the higher seven 20 MHz subchannels (e.g., 996+484+242-tone). The Partial BW Information indicated in the STA Infor field of STA2 is [0 1 0 1 1 1 11 1], which requests the feedback of the lowest 20 MHz and highest seven 20 MHz subchannels (e.g., 996+484+242-tone). In this case, the occupied subchannels of NDP may be all eight 20 MHz subchannels.

In example case #3 of FIG. 11, the Partial BW Information indicated in the STA Infor field of STA1 and STA2 may be [0 1 0 0 0 0 0 0 0], which indicates the feedback of only the first low 20 MHz subchannel (e.g., 242-tone) in both STAs. In this case, the occupied subchannel of NDP indicated by the BW and Puncturing Channel Information fields in the U-SIG field of the NDP may be at least the first 20 MHz subchannel.

In example case #4 of FIG. 11, the Partial BW Information indicated in the STA Infor field of STA1 may be [0 1 0 0 0 0 0 0 0], which indicates the feedback of the first low 20 MHz subchannel (242-tone); the Partial BW Information indicated in the STA Infor field of STA2 is [0 0 0 1 0 0 0 0 0], which indicates the feedback of the 2nd lowest 20 MHz (242-tone). In this case, the occupied subchannel of NDP indicated by the BW and Puncturing Channel Information fields in the U-SIG field of the NDP may be at least the first four 20 MHz channels.

The below described methods and signaling may be used to enable OFDMA puncturing patterns for UL transmissions. A new combination of UL/DL and PPDU Type And Compression Mode, as shown in Table 3 below, may be defined. With this combination, the UL/DL subfield may be set=1 (for UL) and the PPDU Type And Compression Mode subfield may be set=2 to identify a puncturing pattern is included. In one example embodiment, the EHT MU PPDU may be used and an EHT-SIG field may present. The RU allocation subfield may or may not present. The total number of User fields may be zero, one or more. With this mode embodiment, an OFDMA puncturing pattern may be indicated in a Punctured Channel Info subfield in U-SIG.

TABLE 3
Combination of UL/DL and PPDU Type And Compression Mode field for UL

| | | Description | | | | |
|---|---|---|---|---|---|---|
| U-SIG fields | | | | | Total number | |
| | PPDU | | | RU | ofUser fields | |
| | Type And | EHT | | Allocation | in MU PPDU | |
| | Compression | PPDU | EHT-SIG | subfields | or transmitters | |
| UL/DL | Mode | format | present? | present? | in TB PPDU | Note |
| 1 (UL) | 0 | EHT TB | No | — | □ 1 | UL OFDMA orUL non- |
| | | | | | | OFDMA |
| | | | | | | (including non-MU- |
| | | | | | | MIMO and MU- |
| | | | | | | MIMO) |
| | 1 | EHT MU | Yes | No | 1 for | Transmission to a single |
| | | | | | transmission | user or NDP (To AP, i.e., |
| | | | | | to asingle | “UL”) |
| | | | | | user; 0 for | |
| | | | | | NDP | |
| | 2 | EHT MU | Yes | Yes or No | 0, and/or 1 for | Transmission to one or |
| | | | | | transmission | more AP using OFMDA |
| | | | | | to a single | puncturing pattern |
| | | | | | AP; and/or >1 | |
| | | | | | for MAP | |
| | 3 | — | — | — | — | Validate if |
| | | | | | | dot11EHTBaseLineFea- |
| | | | | | | turesImplementedOnly |
| | | | | | | equals true |

Embodiments for setting of Punctured Channel Information subfield in a U-SIG field of a PPDU may follow certain rules described below.

In one embodiment, an ODMA puncturing pattern may be indicated when 4-bits are used in the Punctured Channel Information subfield. A 4-bit bitmap may be used to indicate which 20 MHz subchannel(s) is punctured in the relevant 80 MHz subblock for OFDMA puncturing, for example, a first case when the PPDU Type And Compression Mode subfield is set=0, or a second case when the UL/DL subfield is set=1 (UL) and the PPDU Type And Compression Mode subfield is set=2.

When 5-bits are present in the Punctured Channel Information subfield, the subfield may point to the entry of a bandwidth dependent table (i.e., a non-OFDMA puncturing pattern is used) if case 1 (the PPDU Type And Compression Mode subfield is set to 1) or case 2 (the UL/DL subfield=0 (DL) and the PPDU Type And Compression Mode subfield is set to 2).

In various embodiments, an EHT AP or an EHT+AP may announce a BSS operating channel width using EHT or EHT+Operation element. In a first option, the announced BSS operating channel width is the maximum width including the primary channel and punctured 20 MHz subchannel indicated in the Disabled Subchannel Bitmap field in the EHT/EHT+Operation element. In one embodiment, a rule for utilizing Disabled Subchannel Bitmap field may be modified to follow the OFDMA puncture pattern defined in IEEE P802.11be/D8.0.

In a second option, the announced BSS operating channel width may be the maximum width including the primary channel and any punctured 20 MHz subchannel indicated in the Disabled Subchannel Bitmap field in the EHT/EHT+Operation element and other potentially or dynamically punctured 20 MHz subchannel(s).

With the second option, the disabled subchannel(s) indicated in the Disabled Subchannel Bitmap field in the EHT/EHT+Operation element may identify a further subset of the disabled/punctured subchannels. The EHT/EHT+AP and non-AP STAs may puncture additional subchannels dynamically in each individual transmission. In one embodiment, the Disabled Subchannel Bitmap field may be set to a value which may indicate disabled subchannels in a primary 40 MHz/80 MHz/160 MHz subchannel as accurately, or as up to date, as possible. In one method, the AP may not include any 20 MHz subchannels specified in the Disabled Subchannel Bitmap field. With this option, the unavailable subchannels which can't be indicated in the Disabled Subchannel Bitmap field may be indicated dynamically in each individual transmission. And therefore, the AP may be able a announce a wide BSS operating channel width.

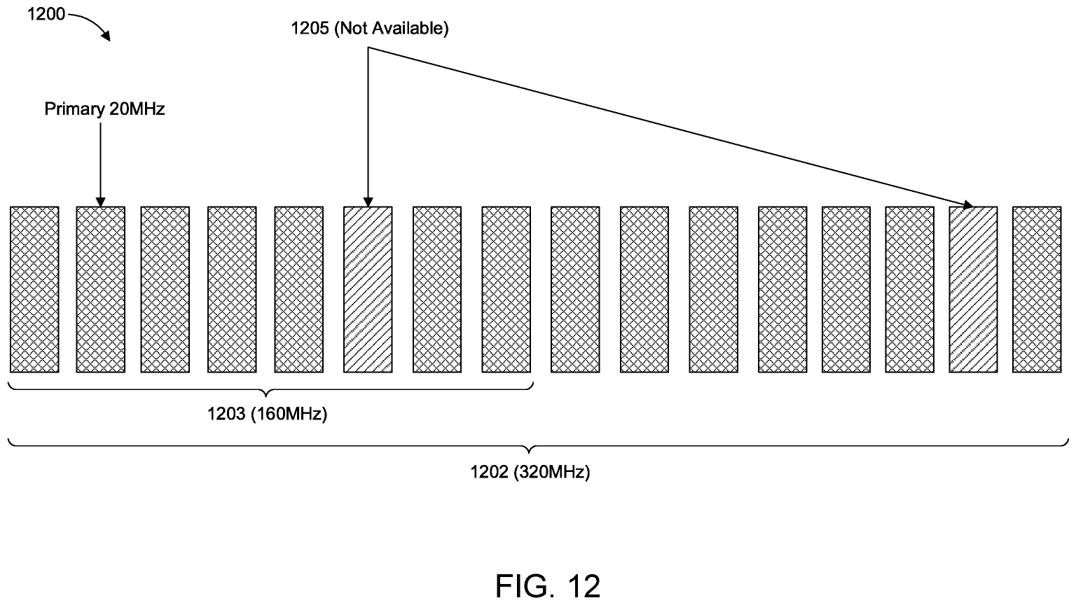

In an example channel map 1200 shown in FIG. 12, an EHT AP may be able to operate on a 320 MHz channel 1202. It may observe two 20 MHz subchannels 1205 that may not be available or may not be available later within the 320 MHz channel width 1202. Based on prior specification definitions, it was not possible to indicate both 20 MHz subchannels 1205 are disabled in a Disabled Subchannel Bitmap field using existing rules defined in 802.11be. Using the first option of the previously described embodiments, the EHT/EHT+AP may set an operation channel width 1203 as 160 MHz since the non-available 20 MHz subchannel 1205 can be indicated in the Disabled Subchannel bitmap when the channel width is 160 MHz.

Following the second option, the EHT/EHT+AP may set operation channel width 1202 as 320 MHz. Based on the prior defined rules, it may not be possible to indicate both 20 MHz subchannels 1205 as disabled in the Disabled Subchannel Bitmap field. In one method, the AP may use Disabled Subchannel Bitmap to indicate the unavailable 20 MHz subchannel in the primary 160 MHz (1203) for the entire BSS. In the individual transmission with BW 320 MHz, the AP or a non-AP STA may indicate the unavailable 20 MHz subchannel in the secondary 160 MHz channel using PHY header or MAC body dynamically. In the individual transmission with BW 160 MHz or less, the AP or a non-AP STA may not need to indicate the unavailable 20 MHz subchannel in the secondary 160 MHz channel. As used throughout this disclosure, EHT+may refer to an IEEE 802.11 amendment which is later than 802.11be drafts at the time of this disclosure. Further, EHT+ is not limited to 802.11 standards where similar advantages might be applicable to future or other wireless technologies. The embodiments discussed previously may be applied to one, any or all of the further embodiments disclosed herein.

Embodiments for one or more methods and apparatuses to enable dynamic puncturing when puncturing channel information may be carried in a PHY layer in PPDU are now described. As used herein, a “non-HT PPDU” refers to a legacy PPDU (before 802.11 n). A “non-HT duplicate PPDU” refers to a PPDU transmitted using non-HT PPDU format for a 20 MHz subchannel and duplicating it in the one or more 20 MHz subchannels. A non-HT duplicate PPDU may be used to carry frames so that legacy STAs may understand the transmission and set NAV properly.

A non-HT PPDU or non-HT duplicate PPDU includes a legacy signal (L-SIG) field in PHY header. The L-SIG field is 24-bits with a Length subfield of 12-bits which can have a value between 0 and 4095. L-SIG has no signaling for punctured channels previously defined.

In one embodiment, puncturing information may be partially carried in the PHY header of a non-HT duplicate PPDU. A non-HT duplicate PPDU may carry the legacy short training field (L-STF), legacy long training field (L-LTF) and the L-SIG fields which may occupy 52 tones (including 48 data tones and 4 pilot tones) per OFDM symbol in every 20 MHz bandwidth. However, any STA which supports HT or newer version may be able to detect 56 tones per OFDM symbol in every 20 MHz bandwidth. In other words, there are 4 extra tones which are not used by non-HT PPDU but could be detected by a STA which support HT or newer PHY versions. In some embodiments, these “extra” tones may be used to carry information about punctured channel information or dynamically/additionally punctured channel information.

In one example embodiment, the extra tones may be used to indicate whether dynamic/additional puncturing is performed in the PPDU. In another example embodiment, the extra tones may be used to indicate whether preamble puncturing (including both dynamic puncture and static puncture) is performed in the PPDU.

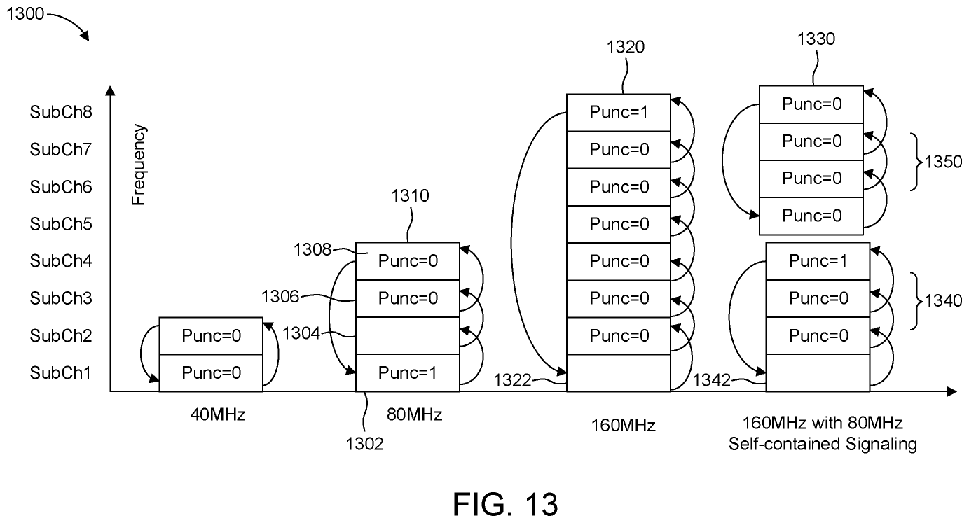

Referring to FIG. 13, another example embodiment may utilize cascade signaling. In cascade signaling, extra tones may be used to indicate whether preamble puncturing is performed in another 20 MHz subchannel. For example, if the non-HT duplicate PPDU is transmitted over a 20 MHz channel, the signaling transmitted over the extra tones may be reserved. If the non-HT duplicate PPDU is transmitted over a channel with bandwidth greater than 20 MHz, the signaling transmitted over the extra tones on the 20 MHz subchannel with the lowest frequencies may be used to indicate whether the next 20 MHz subchannel is punctured. The signaling on the 20 MHz subchannel with the highest frequencies may be used to indicate the puncture status of the 20 MHz subchannel with the lowest frequencies.

Examples of signaling with different channel bandwidth are shown in FIG. 13. In the examples, each block refers to a 20 MHz subchannel, e.g., 80 MHz channel 1310 includes four 20 MHz blocks 1302-1308. Each subchannel may give the subchannel index from the lowest frequency to the highest frequency, therefore the lowest colored block may be referred as subchannel-1. In the example shown of 40 MHz transmission, no subchannel is punctured. Therefore, the punctured channel indications carried in subchannel-1 and subchannel-2 are set=0. In the example of 80 MHz transmission 1310, the subchannel-2 1304 is punctured. Therefore, the punctured channel indication carried in subchannel-1 1302 is set=1 to indicate the subchannel-2 1304 is punctured. The punctured channel indications carried in the rest of subchannels 1306 and 1308 are set=0. FIG. 13 shows a further for 160 MHz transmission 1320 where the first subchannel 1322 is punctured and thus the punctured channel indication carried in the 8^{th} subchannel 1328 is set=1 and the punctured channel indications carried in the remaining subchannels are set=0. In a second example of 160 MHz transmission 1330, two self-contained 80 MHz signaling groups 1340, 1350 using cascade signaling are shown. In this example, Subchannel-1 1342 is punctured and the punctured channel indication carried in subchannel-4 (which is the subchannel with the highest frequency within 80 MHz group 1340) is set=1 and the punctured channel indications carried in the remaining subchannels are set=0. Note, the subchannels are ordered from the lowest frequency to the highest frequency in these examples, there may be other ways to order them and thus signaling to indicate the punctured channel status in another subchannel is generally referred to as “cascade” signaling in this disclosure. Furthermore, although 20 MHz subchannels are used as an example, other subchannel resolutions may also be used and considered within the same embodiments.

In one example embodiment, puncturing information may be fully or partially carried by the SERVICE field of a non-HT duplicate PPDU and/or other types of PPDU. In one example, a single bit in the SERVICE field may be used to indicate dynamic puncturing or preamble puncturing (including both dynamic and static puncturing) may be performed in the PPDU. In another embodiment, the combined bandwidth and puncturing channel information signal methods discussed above and/or Tables previously described may be used.

In one example, a Disabled Subchannel Bitmap field may use non-OFDMA puncturing patterns (as shown in Table 1) to indicate a limited number of puncturing patterns. Dynamic puncturing may be allowed in TXOP level or individual transmission level, and the dynamic puncturing may follow an OFDMA puncturing pattern to enable more punctured patterns. Note, the method disclosed may allow all valid OFDMA puncturing patterns defined in 802.11be or 802.11be+ standard. Moreover, it may allow additional puncturing patterns still to be determined.

According to one example scenario, a TXOP may start with non-HT PPDU(s) and then follow using EHT or EHT+PPDUs. One bit in the non-HT duplicate PPDU (e.g., in SERVICE field or using extra tones or reserved bit in an L-SIG field), or the MAC body carried in the non-HT duplicate PPDU, may indicate that a U-SIG field or enhanced SIG field of the following EHT or EHT+PPDU in the TXOP may use an OFDMA PPDU type/mode and/or an OFDMA puncturing pattern and/or the receiving STAs may need to switch to/open the entire bandwidth to receive the following EHT or EHT+PPDU. The entire bandwidth here may refer to a minimum value among the BSS operation channel width and the maximum bandwidth the STA is capable. The U-SIG field or enhanced SIG field of the following EHT or EHT+PPDU in the TXOP may be different among different 80 MHz subchannels in certain embodiments. Here we use 80 MHz subchannels as example, and other size of subchannels may be possible in a future standards. If this bit is set, the EHT/EHT+PPDU in the TXOP may use OFMDA PPDU type/mod (i.e., the PPDU Type And Compression Mode subfield is set=0 for both DL and UL or the PPDU Type And Compression Mode subfield is set=2 for UL) and/or OFMDA puncturing pattern. An intended receiving STA may need to open the entire bandwidth indicated by the non-HT duplicate PPDU to perform the Start of Packet Detection and/or preamble detection of the EHT or EHT+PPDU if the STA supports that bandwidth. In this way, the STA may detect a U-SIG field or enhanced SIG field in each 80 MHz subchannel and know the full puncturing pattern over the entire bandwidth. An intended STA may use the largest bandwidth it supports to perform Start of Packet Detection and/or preamble detection of the EHT or EHT+PPDU if the STA is not capable to support the bandwidth.

The OFDMA punctured pattern referred in this embodiment is a per 80 MHz bitmap based puncturing pattern and the signaling may be different among different 80 MHz channels in the EHT or EHT+PPDUs. By using an OFDMA punctured pattern of the type described, all of the punctured cases may be signaled and enabled in the TXOP. On reception of the EHT/EHT+PPDU transmitted by the TXOP holder, a TXOP responding STA may extract the punctured channel information carried in the PPDU through the RXVECTOR parameter INACTIVE_SUBCHANNELS or other parameters.

This indication may also be used for the receiver to determine if it may combine signals in different 20 MHz subchannel to achieve better performance. For non-HT dup PPDU that starts the TXOP, if the indication bit is not set, the receiver may combine the received signal on different 20 MHz subchannels (which are not indicated in the Disabled Subchannel Bitmap) to achieve diversity gain and power gain. Otherwise, the receiver may not combine signals on 20 MHz subchannels. For EHT/EHT+PPDU that transmitted in the TXOP, if the indication bit is not set, the receiver may combine the received L-SIG field, USIG field or enhanced SIG field on different 20 MHz subchannels (which are not indicated in the Disabled Subchannel Bitmap) to achieve diversity gain and power gain. Otherwise, the receiver may not combine signals on 20 MHz subchannels. This indication may also be used for the receiver to perform per-20 MHz energy or signal detection so that the receiver may realize the punctured subchannels.

In certain embodiments, puncturing information may be partially carried in the L-SIG field of a non-HT duplicate PPDU. There is one reserved bit in L-SIG field which may be used to indicate dynamic/additional puncturing (puncturing more subchannels than that indicated in the Disabled Subchannel Bitmap) or preamble puncturing (both static and dynamic puncturing) is performed in the PPDU. The cascade signaling methods mentioned above may be applied here. This indication may be used for the receiver to determine if it may combine signals in different 20 MHz subchannel to achieve better performance. If no subchannel is punctured, the receiver may combine the received signal on different 20 MHz subchannels to get diversity gain and power gain. Otherwise, it may need to combine signals on unpunctured 20 MHz subchannels as mentioned above. This indication may be used for the receiver to perform per-20 MHz energy or signal detection so that the receiver may fully realize punctured subchannels.

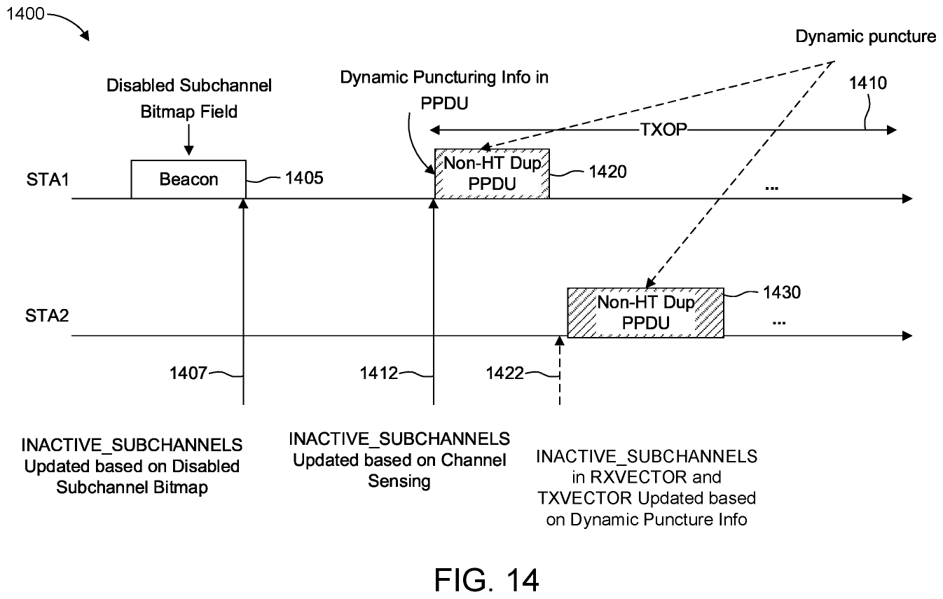

Referring to FIG. 14, an exemplary method 1400 of communicating in a wireless network using dynamic puncturing with Dynamic Puncturing Information signaling carried in the non-HT duplicate PPDU is described. In this example, Dynamic Puncturing Information is used as the signaling field name, however, other names may be used, for example, Wideband Detection Indication, Duplicate SIG Indication etc.

As shown in FIG. 14, an AP may announce static preamble puncturing using a Disabled Subchannel Bitmap field in EHT Operation element in a management frame 1405, such as Beacon frame or association response frame (not shown) or other frames. STAs associated with the AP, e.g., STA1 and/or STA2 in this example, at step 1407 may set the TXVECTOR parameter INACTIVE_SUBCHANNELS of an HE, EHT, EHT+, or non-HT duplicate PPDU based on the Disabled Subchannel Bitmap field. The punctured subchannels indicated in the Disabled Subchannel Bitmap from the AP are referred as statically punctured subchannels.

A STA, e.g., STA1, may acquire the channel and start a TXOP 1410. Here STA1 may be an AP or a non-AP STA and may be referred as the “TXOP holder.”

At 1412, based on latest channel sensing results, STA1 may determine to puncture additional subchannels besides the subchannels indicated by the Disabled Subchannel Bitmap field (any additional subchannels to be punctured are referred as dynamically punctured subchannels). The channel sensing referred at step 1412 here may be energy detection or virtual sensing (i.e., NAV setting). In other words, if STA1 observes high level interference or notices existing transmissions on some subchannels, STA1 may be able to determine to start the TXOP on the unoccupied subchannels (i.e., puncture the occupied subchannels). This determination may need to follow puncturing patterns or rules not described here.

Other STAs which may transmit or receive in the TXOP, e.g., STA2, may not use any punctured subchannels indicated by STA1, the TXOP holder. The punctured subchannels may include the statically punctured and dynamically punctured subchannels.

STA1 may update 1412 the TXVECTOR parameter INACTIVE_SUBCHANNELS of an HE, EHT, EHT+, or non-HT duplicate PPDU to include the subchannels which are not available for the TXOP 1410. The TXVECTOR parameter INACTIVE_SUBCHANNELS may carry information of punctured subchannels, including statically punctured and dynamically punctured subchannels. It should be recognized that the TXVECTOR parameter INACTIVE_SUBCHANNELS is referenced by example to carry statically and dynamically punctured subchannels from MAC layer to PHY layer and the embodiments are not limited in this respect. In the described embodiments, information about statically and dynamically punctured subchannels may be carried in one or more TXVECTOR parameters having other names. Similarly, the RXVECTOR parameter INACTIVE_SUBCHANNELS is one example parameter to carry statically and dynamically punctured subchannels from PHY layer to MAC layer. The information about statically and dynamically punctured subchannels may be carried in one or more RXVECTOR parameters having other names or designations and the embodiments are not limited in this respect.

STA1 may prepare to transmit a PPDU. In the case illustrated, the PPDU may be a non-HT duplicate PPDU 1420, and STA1 may not transmit on punctured subchannels based on the updated TXVECTOR parameter INACTIVE_SUBCHANNELS. STA1 may signal the punctured subchannels (including dynamically punctured and/or statically punctured subchannels) explicitly in the PPDU 1420. Here, the signaling may indicate the full list of punctured subchannels. Alternatively, or in addition, the signaling may indicate static puncturing, dynamic puncturing or both, may be applied in the PPDU and/or the following frame exchanges in the same TXOP. In one embodiment, the signaling may indicate the intended STA(s) may need to switch to wideband reception mode to detect the PPDUs in the TXOP.

A STA, e.g., STA2, may be a desired recipient of the transmission of STA1. On reception of the non-HT duplicate PPDU 1420 transmitted by STA1, STA2 may extract the punctured channel information carried in the PPDU through the RXVECTOR parameter INACTIVE_SUBCHANNELS at 1422. In one method, punctured channel information may be partially signaled in the PPDU 1420, and the RXVECTOR parameter INACTIVE_SUBCHANNELS may be obtained by explicit signaling and receiver measurement. For example, if the signaling indicates one or more subchannels may be punctured in the PPDU 1420 but the full list of punctured subchannels is not available, the receiver of STA2 may perform per subchannel energy detection. If the detected energy on a subchannel is below certain energy threshold, the receiver of STA2 may determine that subchannel is a punctured subchannel and indicate that using the RXVECTOR parameter INACTIVE_SUBCHANNELS at 1422. The energy threshold may be predefined or determined and signaled by the associated AP using management/control/data frames.

In one method, STA2 may set the TXVECTOR parameter INACTIVE_SUBCHANNELS based on the latest RXVECTOR parameter INACTIVE_SUBCHANNELS and the latest received Disabled Subchannel Bitmap field, for example from the AP beacon 1405. With this method, the PPDU transmitted from STA2 has the same punctured subchannels as the PPDU transmitted from STA1. In another word, STA1, as the TXOP holder, may determine the punctured subchannels for the TXOP. STA2 may not be allowed to puncture additional subchannels.

In another method, STA2 may set the TXVECTOR parameter INACTIVE_SUBCHANNELS based on the RXVECTOR parameter INACTIVE_SUBCHANNELS, the latest received Disabled Subchannel Bitmap field and its latest sensing results. For example, it may set the TXVECTOR parameter INACTIVE_SUBCHANNELS as the subchannel union of punctured subchannel(s) indicated by the RXVECTOR parameter INACTIVE_SUBCHANNELS and subchannel(s) identified as busy by the last channel sensing results and disabled subchannel(s) in the latest received Disabled Subchannel Bitmap field. In one example, this last method may only be used when the responding STA (e.g., STA2 in this example) may not solicit any transmissions. With this method, the PPDU transmitted from STA2 may have the additional the punctured subchannels comparing to the PPDU transmitted from STA1. In another word, STA2 may not be allowed to puncture additional subchannels in a TXOP initiated by STA1.

STA2 may prepare to transmit using the TXVECTOR parameter INACTIVE_SUBCHANNELS. In other words, STA2 may not transmit anything in the punctured subchannel indicated in the TXVECTOR parameter INACTIVE_SUBCHANNELS. STA2 may signal the punctured channels in either PHY header or MAC header/body in the transmitted PPDU 1430.

An enhanced PPDU may refer to a PPDU which may be defined in the latest active amendment or future amendment so that the signaling field may include the punctured channel information, e.g., EHT MU PPDU or EHT+PPDU etc. To enable dynamic puncturing with enhanced PPDUs, the procedure mentioned in FIG. 14 may be applied.

In another embodiment, punctured channel information may be carried in MAC frame, e.g., MAC header and/or MAC body. For example, the punctured channel information may be carried in A-Control field in MAC header. A new Control ID may be used for Punctured Channel Control as shown in Table 4 below. Note the Control ID value 11 is used as example. The Length of Control information subfield may beg 16 bits, 24 bits or other size.

TABLE 4
Control ID Subfield Values

| Control ID | | Length of the Control |
|---|---|---|
| value | Meaning | Information subfield (bits) |
| . . . | . . . | . . . |
| 11 | Punctured Channel | 16 or 24 |
| | Control (PCC) | |
| . . . | . . . | . . . |

The Control Information subfield in a PCC Control subfield contains punctured channel information. In one method, a bitmap may be used where each bit may indicate a 20 MHz subchannel. If a bit is set to 0(or 1), the corresponding 20 MHz subchannel may not be punctured. If a bit is set to the opposite, e.g., 1(or 0), the corresponding 20 MHz subchannel may be punctured.

In one example embodiment, both bandwidth and punctured channel information may be carried in A-Control field in MAC header. In one method, separate Control ID values may be given for bandwidth and punctured channel control fields. In one method, a Control ID value may be given for Combined Bandwidth and Punctured channel control field (CBP). The Control Information subfield in a CBP Control subfield may contain Combined Bandwidth and Punctured Channel Information (CBPCI) subfield and Reserved subfield. One example of a look-up table having signaling for the combined information CBPCI is shown in Table 5 below. If a particular CBPCI value is indicated, the corresponding bandwidth and punctured pattern is utilized. In the puncturing patterns in the table, a “1” denotes a non-punctured subchannel and a “x” denotes a punctured subchannel and each subchannel is 20 MHz.

TABLE 5
Exemplary Table for Combined Bandwidth
and Punctured Channel Information Signaling

| CBPCI value | Bandwidth | Punctured pattern |
|---|---|---|
| 0 | 20 | No puncturing |
| 1 | 40 | No puncturing |
| 2 | 80 | No puncturing |
| 3 | 80 | ×111 |
| 4 | 80 | 1×11 |
| 5 | 80 | 11×1 |
| 6 | 80 | 111x |
| 7 | 80 | 1xx1 |
| 8 | 160 | No puncturing |
| 9 | 160 | x1111111 |
| 10 | 160 | 1×111111 |
| 11 | 160 | 11×11111 |
| 12 | 160 | 111×1111 |
| 13 | 160 | 1111x111 |
| 14 | 160 | 11111x11 |
| 15 | 160 | 111111×1 |
| 16 | 160 | 1111111x |
| 17 | 160 | xx111111 |
| 18 | 160 | 11xx1111 |
| 19 | 160 | 1111xx11 |
| 20 | 160 | 111111xx |
| 21 | 320 | No puncturing |
| 22 | 320 | xx11111111111111 |
| 23 | 320 | 11xx111111111111 |
| 24 | 320 | 1111xx1111111111 |
| 25 | 320 | 111111xx11111111 |
| 26 | 320 | 11111111xx111111 |
| 27 | 320 | 1111111111xx1111 |
| 28 | 320 | 111111111111xx11 |
| 29 | 320 | 11111111111111xx |
| 30 | 320 | xxxx111111111111 |
| 31 | 320 | 1111xxxx11111111 |
| 32 | 320 | 11111111xxxx1111 |
| 33 | 320 | 111111111111xxxx |
| 34 | 320 | xxxxxx1111111111 |
| 35 | 320 | xxxx11xx11111111 |
| 36 | 320 | xxxx1111xx111111 |
| 37 | 320 | xxxx111111xx1111 |
| 38 | 320 | xxxx11111111xx11 |
| 39 | 320 | xxxx1111111111xx |
| 40 | 320 | xx1111111111xxxx |
| 41 | 320 | 11xx11111111xxxx |
| 42 | 320 | 1111xx111111xxxx |
| 43 | 320 | 111111xx1111xxxx |
| 44 | 320 | 11111111xx11xxxx |
| 45 | 320 | 1111111111xxxxxx |

The signaling method described in Table 4 may be a general method for combined bandwidth and puncture pattern signaling if desired. For example, it may be used in PHY layer header, such as USIG or EHT-SIG or other type of SIG fields. Table 4 provides a simplified example and actual signaling may have an additional or a smaller number of punctured patterns, additional or smaller number of bandwidth types, different resolution of subchannels etc.

In other example embodiments, punctured channel information may be carried in MAC body of some control frames, e.g., MU-RTS frame, NDPA frame, Trigger frame, MU-BAR frame etc.

In one method, a Disabled Subchannel Bitmap field may use non-OFDMA puncturing patterns (e.g., as shown in Table 1) to indicate limited number of puncturing patterns. While a dynamic puncturing may be allowed in TXOP level and the dynamic puncturing may follow OFDMA puncturing pattern to enable more punctured patterns. Note, the method disclosed may allow all valid OFDMA puncturing patterns defined in 802.11be. Moreover, it may allow additional puncturing patterns currently not defined in 802.11be.

A TXOP may start with non-HT PPDU(s) and then follow by EHT or EHT+PPDUs. The non-HT PPDU may carry punctured channel information using one or more methods mentioned above. In one example, a control frame may be defined to carry the full list of punctured channels for the remaining TXOP, and/or TXOP operation bandwidth, and may be transmitted at the beginning of the TXOP, or in the middle of the TXOP, to announce the puncture subchannels and the bandwidth for the remaining TXOP. In one example, one bit in the MAC frame carried by the non-HT duplicate PPDU (e.g., in MAC header and/or A-Control field, and/or Control Wrapper, and/or MAC body) may indicate that the U-SIG field or enhanced SIG field of the following EHT or EHT+PPDU in the TXOP may use OFDMA PPDU type/mode and/or OFDMA puncturing pattern, and the U-SIG field may be different among different 80 MHz subchannels. Or the bit may indicate the intended receiving STA needs to switch to wideband reception mode to receive the PPDUs in the TXOP. The bit may be referred as Dynamic Puncturing Information field. If this bit is set, the EHT/EHT+PPDU in the TXOP may use OFMDA PPDU type/mod (i.e., the PPDU Type And Compression Mode subfield is set=0 for both DL and UL or the PPDU Type And Compression Mode subfield is set to 2 for UL) and/or OFMDA puncturing pattern. An intended receiving STA may need to open the entire bandwidth indicated by the non-HT duplicate PPDU to perform the Start of Packet Detection and/or preamble detection of the EHT or EHT+PPDU if the STA supports that bandwidth. In this way, the STA may detect U-SIG field or enhanced SIG field in each 80 MHz subchannel and know the full puncturing pattern over the entire bandwidth. An intended STA may use the largest bandwidth it supports to perform Start of Packet Detection and/or preamble detection of the EHT or EHT+PPDU if the STA is not capable to support the bandwidth, as before. Here we use Dynamic Puncturing Information as the signaling field name, however, other names may be used, for example, Wideband Detection Indication, Duplicate SIG Indication, etc.

The OFDMA punctured pattern referred here is a per 80 MHz bitmap based puncturing pattern and the signaling may be different among different 80 MHz channels in the EHT or EHT+PPDUs. By using OFDMA punctured pattern, all of the punctured cases may be signaled and enabled in the TXOP. On reception of the EHT/EHT+PPDU transmitted by the TXOP holder, a TXOP responding STA may extract the punctured channel information carried in the PPDU through the RXVECTOR parameter INACTIVE_SUBCHANNELS as previously discussed.

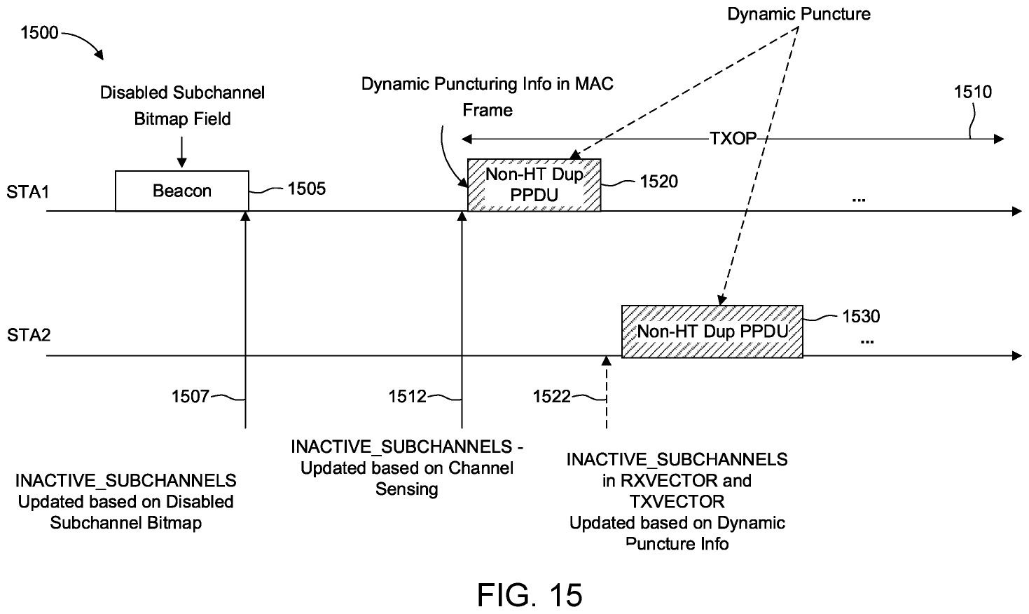

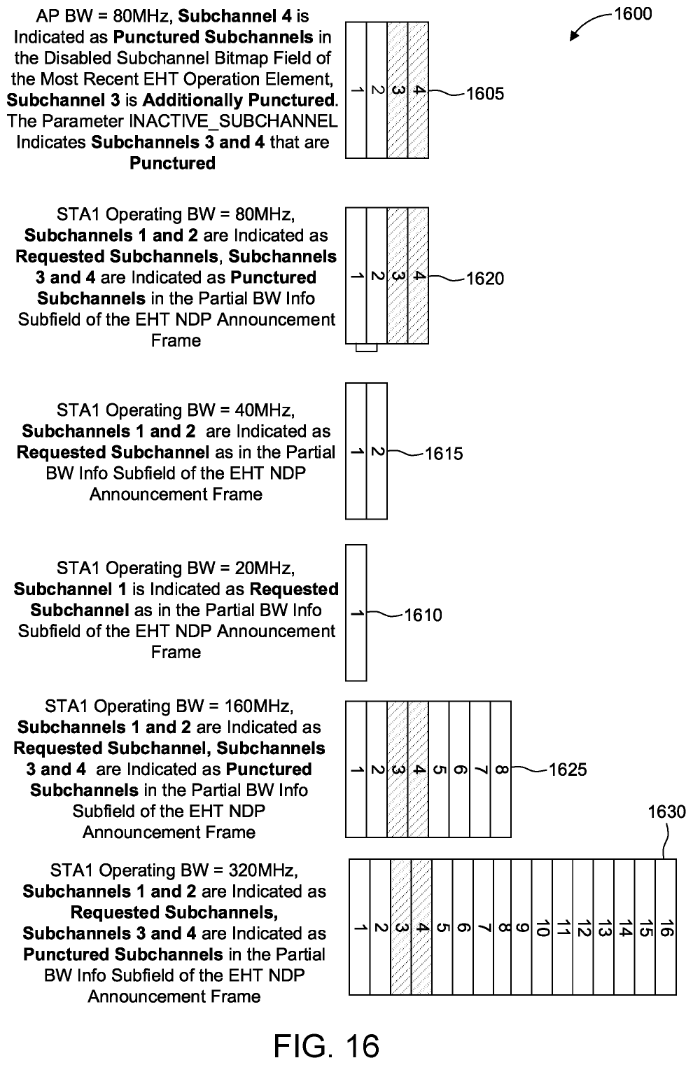

Referring to FIG. 15, a method 1500 of wireless communication using dynamic puncturing when the Dynamic Puncturing Information is carried in the MAC header and/or MAC body is described. In this embodiment, the RXVECTOR parameter INACTIVE_SUBCHANNELS may not need to be defined, as in the embodiment described referring to FIG. 14, since the MAC layer may extract the punctured channel information directly by decoding the MAC frame. Although FIG. 15 illustrates non-HT duplicate PPDU, other types of PPDU may be used.

As shown in FIG. 15, an AP may announce static preamble puncturing using Disabled Subchannel Bitmap field in EHT Operation element in a management frame 1505, such as Beacon frame or association response frame, as before. STAs associated with the AP, e.g., STA1 and/or STA2 in this example, may set the TXVECTOR parameter INACTIVE_SUBCHANNELS of an HE, EHT, EHT+, or non-HT duplicate PPDU based in the Disabled Subchannel Bitmap field at 1507. The punctured subchannels indicated in the Disabled Subchannel Bitmap are referred as statically punctured subchannels.

A STA, e.g., STA1, may acquire the channel and start a TXOP at 1510. Here STA1 may be an AP or a non-AP STA. STA1, referred to as the TXOP holder. Based on latest channel sensing results at 1512, STA1 may determine to puncture additional subchannels besides the subchannels indicated by the Disabled Subchannel Bitmap field (the additional subchannels to be punctured are referred as dynamically punctured subchannels). The channel sensing referred here may be energy detection or virtual sensing (i.e., NAV setting). In other words, if STA1 observes high level interference or notices existing transmissions on some subchannels, STA1 may be able to determine to start the TXOP on the unoccupied subchannels. The determination may need to follow existing puncturing patterns or rules. Other STAs which may transmit or receive in the TXOP may not use any punctured subchannels indicated by STA1, the TXOP holder. The punctured subchannels may include the statically punctured from the bitmap and, if any, dynamically punctured subchannels. STA1 may update the TXVECTOR parameter INACTIVE_SUBCHANNELS of an HE, EHT, EHT+, or non-HT duplicate PPDU to include the subchannels which are not available for the TXOP. The TXVECTOR parameter INACTIVE_SUBCHANNELS may carry information of punctured subchannels, including statically punctured and dynamically punctured subchannels. STA1 may prepare to transmit a PPDU 1520 which carries at least one MAC frame. STA1 may not transmit on punctured subchannels based on the TXVECTOR parameter INACTIVE_SUBCHANNELS. STA1 may signal the punctured subchannels (including dynamically punctured and/or statically punctured subchannels) explicitly in the MAC header or MAC body of the MAC frame of PPDU 1520. The signaling may indicate the full list of punctured subchannels. Alternatively, it may indicate static puncturing or dynamic puncturing or both may be applied in the PPDU and/or the following frame exchanges in the same TXOP. In one embodiment, the signaling may indicate the intended STA(s) may need to switch to wideband reception mode to detect the PPDUs in the TXOP.

A STA, e.g., STA2, may be a desired recipient of the transmission of STA1. On reception of the frame 1520 transmitted by STA1, STA2 may extract the punctured channel information carried in the MAC header and/or MAC body of PPDU 1520. In one embodiment STA2 may set 1522 the TXVECTOR parameter INACTIVE_SUBCHANNELS based on the punctured channel information received in MAC layer and the latest received Disabled Subchannel Bitmap (if it is not included in the TXVECTOR parameter INACTIVE_SUBCHANNELS). In another method, STA2 may set the TXVECTOR parameter INACTIVE_SUBCHANNELS based on the punctured channel information received in MAC layer, the latest received Disabled Subchannel Bitmap (if it is not included in the TXVECTOR parameter INACTIVE_SUBCHANNELS), and its latest channel sensing results. For example, it may set the TXVECTOR parameter INACTIVE_SUBCHANNELS as the subchannel union of punctured subchannel(s) indicated in the received MAC frame and subchannel(s) identified as busy by the last channel sensing results and subchannel(s) indicated in the latest received Disabled Subchannel Bitmap. In one example, this second method may only be used when the responding STA (e.g., STA2 in this example) may not solicit any transmissions.

STA2 may prepare to transmit 1530 using the TXVECTOR parameter INACTIVE_SUBCHANNELS. In other words, STA2 may not transmit anything in the punctured subchannel indicated in the TXVECTOR parameter INACTIVE_SUBCHANNELS. STA2 may signal the punctured channels in either PHY header or MAC header/body in the transmitted PPDU 1530. Although FIG. 15 illustrates non-HT duplicate PPDUs 1520, 1530, other types of PPDUs may be used.

In a non-TB sounding sequence, a single user (SU) beamformer may solicit partial bandwidth feedback from an SU beamformee in an EHT or EHT beyond non-TB sounding sequence. In the non-TB sounding sequence which supports dynamic puncturing performed by the beamformer, the occupied subchannel(s) indicated by the BW and Puncturing Channel Information fields in the U-SIG field of the null data packet (NDP) may be the same as the requested subchannel(s) indicated in the Partial BW Info subfield of the immediately preceding EHT NDP Announcement (NDPA) frame. The NDP Announcement frame carried by EHT multi-user (MU) PPDU or non-HT duplicated PPDU may not be transmitted on subchannels which are indicated in the INACTIVE_SUBCHANNELS. The punctured subchannel(s) indicated by the BW field and Puncturing Channel Information fields in the U-SIG of NDP may include additional punctured subchannel(s) other than those indicated in the Disabled Subchannel Bitmap field of the most recent EHT Operation element for the non-TB sounding initiated by the STA that supports dynamic puncturing. In other words, both statically punctured subchannel(s) indicated by the Disabled Subchannel Bitmap field and additional/dynamical punctured subchannel(s) may not be requested in the Partial BW Info subfield of the immediately preceding EHT NDP Announcement (NDPA) frame. In certain embodiments, both the NDPA frame and the NDP PPDU may be dynamically punctured.

FIG. 16 shows example configurations 1600 of communicating in a wireless network with non-TB sounding with dynamic puncturing. In this example, the indication of TXVECTOR INACTIVE_SUBCHANNELS parameter and the indications of Partial BW Info subfield of the EHT NDP Announcement frame are given for the cases when the beamformer operating BW=80 MHz 1605 and the beamformee operating BW=20 MHz 1610, 40 MHz 1615, 80 MHz 1620, 160 MHz 1625 and 320 MHz 1630, respectively.

When the beamformee receives the NDPA and NDP, the PHY layer of the beamformee may detect the punctured subchannels pattern and set the INACTIVE_SUBCHANNEL as the punctured subchannels pattern based on detection. Then INACTIVE_SUBCHANNEL is passed from the PHY layer to the MAC layer. Alternatively, the recipient STA may use the Partial BW Info subfield of the EHT NDPA frame to determine the punctured channel pattern (or the requested subchannels for feedback). The punctured subchannel(s) may include those indicated in the Disabled Subchannel Bitmap field of the most recent EHT Operation element and additional punctured subchannel(s) if the dynamic puncturing exists in this non-TB sounding sequence. Various scenarios are presented in FIG. 16.

There are multiple ways for the receiver/beamformee to determine if dynamic puncturing exists in the non-TB sounding sequence or any one-to-one transmission. One option is to compare the punctured channel pattern indicated by the INACTIVE_SUBCHANNELS passed from the PHY with the punctured channel pattern indicated in the Disabled Subchannel Bitmap field of the EHT Operation element within the sounding BW (or the NDP BW or the received PPDU BW). If the number of punctured subchannels indicated by the RXVECTOR parameter INACATIVE_SUBCHANNELS is larger than the number of punctured subchannels indicated in the Disabled Subchannel Bitmap field of the EHT Operation element, then the dynamic puncturing exists in the transmission, e.g., non-TB sounding. If the number of punctured subchannels indicated by the RXVECTOR parameter INACATIVE_SUBCHANNELS equals the number of punctured subchannels indicated in the Disabled Subchannel Bitmap field of the EHT Operation element, then the dynamic puncturing does not exist in the transmission, e.g., non-TB sounding. Another option is to compare the punctured subchannel(s) indicated in the Partial BW Info subfield of the NDP Announcement frame with the punctured subchannel(s) indicated in the Disabled Subchannel Bitmap field of the EHT Operation element within the sounding BW (or the NDP BW or the received PPDU BW). If the number of the punctured subchannels indicated in the Partial BW Info subfield of the NDP Announcement frame is larger than the number of the punctured subchannels indicated in the Disabled Subchannel Bitmap field of the EHT Operation element, then the dynamic puncturing exists in this transmission, e.g., non-TB sounding. If the number of the punctured subchannels indicated in the Partial BW Info subfield of the NDP Announcement frame equals the number of the punctured subchannels indicated in the Disabled Subchannel Bitmap field of the EHT Operation element, then the dynamic puncturing does not exist in the transmission, e.g., non-TB sounding.

In one embodiment, to accommodate the dynamic puncturing, example enhanced settings for BW, Partial BW Info subfield in the EHT NDP Announcement frame is given in Table 6 below. The enhanced 5-bit punctured channel indication for the non-OFDMA case in an EHT MU PPTU is presented in Table 7 below.

TABLE 6
Enhanced Settings for BW Info Subfield in the EHT NDP Announcement Frame

| Feedback | Bandwidth of the | Partial BW Info subfield | Operating channel |
|---|---|---|---|
| RU/ | EHT NDP | values in binary format | width of the EHT |
| MRU | Announcement | (B0 B1 B2 B3 B4 | beamformee (MHz) |
| size | frame (MHz) | B5 B6 B7 B8) | |
| 242 + | 80 | 010010000 | 80, 160, 320 |
| 242 | 160 | 01001000, 010000100, 010000010, | 160, 320 |
| | | 010000001 | |
| 242 + | 160 | 011111000, 011110100, 011110100, | 160, 320 |
| 996 | | 011110001, 010001111, 001001111, | |
| | | 001001111, 000011111 | |

TABLE 7
Enhanced 5-bit Punctured Channel
Indication for the Non-OFDMA
Case in an EHT MU PPDU

| PPDU | | Puncturing | Field |
|---|---|---|---|
| bandwidth | Cases | pattern | Value |
| 80 MHz | 40 MHz | [1 x x 1] | 5 |
| | puncturing | | |
| 160 MHz | 60 MHz | [11111xxx] | 13 |
| | puncturing | [1111x1xx] | 14 |
| | | [1111xx1x] | 15 |
| | | [1111xxx1] | 16 |
| | | [1xxx1111] | 17 |
| | | [x1xx1111] | 18 |
| | | [xx1x1111] | 19 |
| | | [xxx11111] | 20 |

The Partial BW Info subfield in a NDPA frame may be modified to carry possible requested RU/MRU and combination of RUs/MRUs with OFDMA puncturing pattern.

With existing allowed OFDMA puncturing pattern (for an 80 MHz subchannel are: 1111 (no puncturing), 0111, 1011, 1101, 1110, 0011, 1100 and 1001), two-hole puncturing may be possible in 160 MHz case. Any combination of allowed 80 MHz puncturing pattern is a valid OFDMA puncturing pattern for 160 MHz operation. For example, 11101100 is a valid OFDMA puncturing pattern with two holes for 160 MHz operation where “0” means the corresponding 20 MHz subchannel is punctured (a hole). Similarly, four-hole puncturing may be possible in 320 MHz channel.

To support an OFDMA puncturing pattern, the Partial BW Info subfield may be modified to signal the request un-punctured RU/MRU/subchannel or combination of RUs/MRU/subchannels on which the channel measurement may be performed. Existing Partial BW Info subfield is 9-bits long, where the first bit may indicate the resolution of the bitmap and the remaining 8-bits carry an 8-bit bitmap. If the BW of the NDPA frame is less than or equal to 160 MHz, the first bit is set=0 and indicates the resolution of the bitmap is 20 MHz. If the BW of the NDPA frame is 320 MHz, first bit is set=1 and indicates the resolution of the bitmap is 40 MHz.

If the BW of the NDPA frame is less than or equal to 160 MHz, the Partial BW Info field may be modified by adding allowed values to support an OFDMA puncturing pattern. Table 8 below shows an example of valid settings for Partial BW Info subfield in NDPA when the feedback back RU/MRU size is 242+242, the BW of the NDPA is 160 MHz and the operating channel width of the beamformee is 160 MHz/320 MHz.

TABLE 8
Examples of More Valid Settings for Partial BW Info Subfield
in the EHT NDP Announcement Frame When the Feedback
RU/MRU size is 242 + 242, and channel bandwidth is 160 MHz

| | Bandwidth of the | Partial BW Info subfield | |
|---|---|---|---|
| Feedback | EHT NDP | values in binary format | Operating channel |
| RU/MRU | Announcement | (B0 B1 B2 B3 B4 | width of the EHT |
| size | frame (MHz) | B5 B6 B7 B8) | beamformee (MHz) |
| 242 + 242 | 160 | 01001000, 000001001, | 160, 320 |
| | | 010001000,010000100, 010000010, | |
| | | 010000001, 001001000, 001000100, | |
| | | 001000010, 001000001, | |
| | | 000101000, 000100100, 000100010, | |
| | | 000100001, | |
| | | 000011000, 000010100, 000010010, | |
| | | 000010001, | |

If the BW of the NDPA frame is 320 MHz, it may be difficult to support all the OFDMA puncturing patterns since the bitmap carried in existing Partial BW Info field has a resolution of 40 MHz. Therefore, 242+242 RU/MRU request may be challenging. However, more valid settings may be added to the Partial BW Info subfield to enable more (if not all) OFDMA puncturing patterns.

Table 9 below shows an example of valid settings for Partial BW Info subfield in NDPA when the feedback back RU/MRU size is 484+484, the BW of the NDPA is 320 MHz and the operating channel width of the beamformee is 320 MHz.

TABLE 9
Examples of more valid settings for Partial BW Info subfield
in the EHT NDP Announcement frame when the Feedback
RU/MRU size is 484 + 484, and channel bandwidth is 320 MHz

| Feedback | Bandwidth of | Partial BW Info subfield | |
|---|---|---|---|
| RU/ | the EHT NDP | values in binary format | Operating channel |
| MRU | Announcement | (B0 B1 B2 B3 B4 | width of the EHT |
| size | frame (MHz) | B5 B6 B7 B8) | beamformee (MHz) |
| 484 + 484 | 320 | 110010000, 100001001, | 320 |
| | | 110001000,110000100, 110000010, | |
| | | 110000001, 101001000, 101000100, | |
| | | 101000010, 101000001, | |
| | | 100101000, 100100100, 100100010, | |
| | | 100100001, | |
| | | 100011000, 100010100, 100010010, | |
| | | 100010001, | |

Table 10 below shows an example of valid settings for Partial BW Info subfield in NDPA when the feedback back RU/MRU size is 484+484+484+484, the BW of the NDPA is 320 MHz and the operating channel width of the beamformee is 320 MHz.

TABLE 10
Examples of More Valid Settings for Partial BW
Info Subfield in the EHT NDP Announcement Frame
when the Feedback RU/MRU Size is 484 + 484 +
484 + 484, and Channel Bandwidth is 320 MHz

| | Bandwidth of the | Partial BW Info subfield | |
|---|---|---|---|
| Feedback | EHT NDP | values in binary format | Operating channel |
| RU/MRU | Announcement | (B0 B1 B2 B3 | width of the EHT |
| size | frame (MHz) | B4 B5 B6 B7 B8) | beamformee (MHz) |
| 484 + 484 + | 320 | 110101010, 110101001, | 320 |
| 484 + 484 | | 110100110, 110100101, | |
| | | 110011010, 110011001, | |
| | | 110010110, 110010101, | |
| | | 101101010, 101101001, | |
| | | 101100110, 101100101, | |
| | | 101011010, 101011001, | |
| | | 101010110, 101010101, | |

In an example channel sounding sequence, the beamformee may experience high interference in one or more of the subchannels that is requested in the NDPA to measure and send the beamforming feedback report. In one embodiment, the beamformee may puncture these subchannels in addition to the punctured subchannels indicated by the NDPA and NDP. The beamformee then prepares the feedback report for the requested subchannels excluding the additionally or “dynamically” punctured subchannels.

In one embodiment, the beamformee in non-TB, and in TB, sounding may puncture additional subchannels of the requested subchannels indicated by the Partial BW Info of the NDPA such that the beamforming feedback report may include only feedback for the requested subchannels excluding the additionally punctured subchannels.

In one embodiment, the beamformee, in non-TB sounding, may send the feedback in a PPDU with preamble puncturing which includes the additionally punctured subchannels and with the additional puncturing indicated in the U-SIG (or any other signaling field in the preamble of the PPDU carrying the beamforming feedback report).

In one embodiment, the beamformee, in TB sounding, may send the feedback in a TB PPDU with additional punctured subchannels such that the feedback may be sent in a subset of the resources allocated by the beamformer in the beamforming report poll (BFRP) trigger frame (TF). The beamformee may indicate the additionally punctured subchannels in the U-SIG (or any other signaling field in the preamble of the PPDU carrying the beamforming feedback report).

For certain embodiments, the MIMO Control field may carry indication of the additionally punctured subchannels to enable the beamformer to successfully interpret the beamforming report. The MIMO Control field is carried in beamforming report transmitted from the beamformee to the beamformer. The punctured subchannel information carried in the MIMO Control field may indicate the subchannels on which the beamforming report may not contain CSI/CQI information, even though the beamformer may request CSI/CQI information on them. In one embodiment, the Partial BW Info subfield of the MIMO Control field may be set by the beamformee rather than copying the Partial BW Info subfield from the NDPA to the MIMO Control field. Accordingly, the Partial BW Info may be used as indicator of the additionally punctured subchannels where the reported subchannels indicated by the Partial BW Info subfield of the MIMO Control field is a superset of the requested subchannels by the Partial BW Info subfield of the NDPA. In this example, the Partial BW subfield in MIMO Control field in the beamforming report is used to carry the reported subchannel information. It may be possible that other field(s)/subfield(s) may be used in the beamforming report to represent the reported subchannels or unreported subchannels.

In another embodiment, some of the reserved bits in the MIMO Control field may be named as Additional Puncturing subfield and may be used as indication for the additional punctured subchannels. In one method, 3-bits may be used as an Additional Puncturing subfield with the exemplary encoding indicated in Table 11 below, where the order of the subchannels is from the subchannel with the lowest frequency to the subchannel with the highest frequency.

TABLE 11
An Example of the Additional
Puncturing subfield Encoding

| Additional | |
|---|---|
| Puncturing | |
| subfield | Meaning |
| 000 | No Additional Puncturing |
| 001 | 1^{st} nonprimary Subchannel is Punctured |
| 010 | 2^{nd} nonprimary Subchannel is Punctured |
| 011 | 3^{rd} nonprimary Subchannel is Punctured |
| 100 | 4^{th} nonprimary Subchannel is Punctured |
| 101 | 5^{th} nonprimary Subchannel is Punctured |
| 110 | 6^{th} nonprimary Subchannel is Punctured |
| 111 | 7^{th} nonprimary Subchannel is Punctured |

In yet further embodiments, the Additional Puncturing subfield in the MIMO Control field may signal the additionally punctured subchannels by indicating the difference between the Partial BW subfield and the actual puncturing. By way of example, the Partial BW subfield may indicate the puncturing pattern 011110000 (=240) and the beamformee may puncture additional subchannels such that that the new puncturing pattern is 011111100 (=252). In one example, the value=1 in the puncturing pattern bitmap means the corresponding subchannel is punctured (not reported). The beamformee may compute the difference between the two puncturing patterns as (252-240=12) which may be represented as the binary sequence “1100.” The beamformee may then indicate the difference “1100” in the Additional Puncturing subfield.

Static and dynamic puncturing may be used in MU-RTS TXS embodiments described herein. In one example, static puncturing may be advertised by Disabled Subchannel Bitmap field in the EHT Operation element, which may be contained in beacons or other control and management frames.

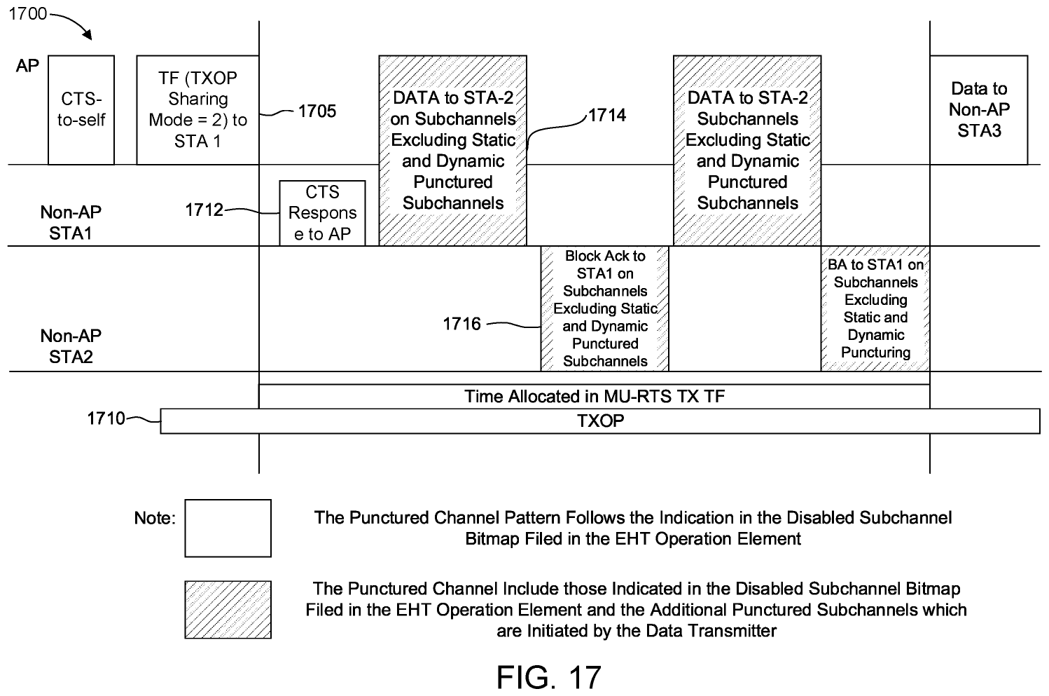

Referring to FIG. 17, a method 1700 for communicating in a wireless network using MU-RTS TXS may include an AP sending a MU-RTS trigger frame 1705, or any trigger frame, having a special user info field which may indicate punctured channel information. Such a special info field may be indicated with a special reserved User Association ID (AID). The punctured channel information may include information of disabled channels as indicated in the Disabled Subchannel Bitmap and may also indicate any additionally punctured channels, which the AP may puncture when initiating a triggered TXS session. In the MU-RTS trigger frame 1705, the AP may assign discontinued RUs, or M-RU, to one or more STAs. In another implementation, the AP may assign a continuous RU in one User Info field, and use a Special User Info field to indicate any punctured RUs/subchannels.

Dynamic puncturing may occur during the shared TXOP 1710, which is triggered by the AP. In this case, the AP may allocate a portion of the time which is an obtained TXOP to an associated non-AP EHT STA, e.g., non-AP STA1 as shown in method 1700 in FIG. 17, for transmitting one or more non-TB PPDUs. After sending the CTS response 1712 to AP, non-AP STA1 determines one or more subchannels which may not be signaled as punctured subchannels in the Disabled Subchannel Bitmap field in the EHT Operation element. Non-AP STA1 punctures these subchannels in addition to those indicated in the Disable Subchannel Bitmap field in the EHT Operation element.

In this example, non-AP STA1 shows all punctured subchannels in the following places: 1) the Puncturing Channel Information fields in the U-SIG field of the transmitted EHT MU-PPDU 1714; and/or 2) TXVECTOR parameter INACTIVE_SUBCHNNELS; 3) and/or TXVECTOR parameters INACTIVE_SUBCHANNELS and DYNAMIC_INACTIVE SUBCHANNELS. The recipient STA, e.g., non-AP STA2 in method 1700 of FIG. 17, detects all punctured subchannels and sets the detected punctured subchannels as punctured subchannels in the RXVECTOR parameter INACTIVE_SUBCHANNELS or RXVECTOR parameters INACTIVE_SUBCHANNELS and DYNAMIC_INACTIVE SUBCHANNELS (if it is present) and pass these parameters from the PHY to MAC layer. Once the MAC layer of non-AP STA2 receives the latest punctured subchannel information, it will allocate the data for its transmissions only on the non-punctured subchannels, which exclude the punctured subchannels indicated in the Disable Subchannel Bitmap field in the EHT Operation element and the additional/dynamic punctured subchannels indicated by non-AP STA1. When non-AP STA2 starts to transmit the response 1716 to non-AP STA1, it should pass the latest punctured subchannels which are included in the TXVECTOR parameter INACTIVE_SUBCHANNELS or TXVECTOR INACTIVE_SUBCHANNELS and DYNAMIC_INACTIVE SUBCHANNELS from the MAC layer to the PHY layer.

Method 1700 of FIG. 17 depicts an example protocol with MU-RTS TXS Trigger frame 1705 with TXOP Sharing Mode subfield value=2 and dynamic puncturing in the frame exchange initiated by non-AP STA1. This protocol may also be applied to the case with MU-RTS TXS Trigger frame with TXOP Sharing Mode subfield value=1. Upon the reception of the MU-RTS frame, non-AP STA1 performs dynamic puncturing when it transmits the CTS response 1712 or a data frame to AP. There are multiple ways for the non-AP STA to determine if dynamic puncturing exists in this one-to-one transmission. One option is to compare the punctured channel pattern indicated by the INACTIVE_SUBCHANNELS passed from the PHY with the punctured channel pattern indicated in the Disabled Subchannel Bitmap field of the EHT Operation element within the NDP BW (or the received PPDU BW). If the number of punctured subchannels indicated by the RXVECTOR parameter INACATIVE_SUBCHANNELS is larger than the number of punctured subchannels indicated in the Disabled Subchannel Bitmap field of the EHT Operation element, then the dynamic puncturing exists in the transmission. If the number of punctured subchannels indicated by the RXVECTOR parameter INACATIVE_SUBCHANNELS equals the number of punctured subchannels indicated in the Disabled Subchannel Bitmap field of the EHT Operation element, then the dynamic puncturing does not exist in the transmission.

In another embodiment, non-AP STA initiates spatial reuse within the time allocated in MU-RTS TX TF 1705. The objective of non-AP STA initiated spatial reuse operation within the time allocated in MU-RTS TX TF is to allow the medium to be reused more often between overlapping basic service sets (OBSSs) in dense deployment scenario by the early identification of signals from the OBSSs and interference management. An EHT STA supporting spatial reuse capabilities for high efficiency (HE) WLAN, such as defined by 802.11 ax, a parameterized spatial reuse (PSR)-based options may be used. A PSR transmission (PSRT) PPDU transmission indicates this by setting the PSR-based spatial reuse (SR) Support subfield=1 in the EHT PHY Capabilities Information in the EHT Capabilities element. As shown in FIG. 17, non-AP STA1 may send out an enhanced CTS 1712 to indicate that the immediate following transmission allows for spatial reuse.

In 320 MHz bandwidth operation, the resolution of the requested subchannels for partial bandwidth feedback in EHT is 40 MHz. For EHT+, if wider bandwidth is supported (e.g., 640 MHz etc.), the resolution of the requested subchannel for partial bandwidth feedback may be values other than 20 MHz. However, for narrow bandwidth operation, the preamble puncturing resolution is still 20 MHz. In one embodiment, a beamformer may request partial bandwidth feedback for a 40 MHz subchannel if at least one of its 20 MHz subchannels is not punctured. In an NDPA frame, or the PPDU carrying the NDPA frame, the AP may indicate an OFDMA puncturing mode may be used in the following NDP PPDU. The beamformee may identify which one, if any, of the two 20 MHz subchannels of the requested 40 MHz feedback is punctured from the Punctured Channel Information field of the U-SIG, or enhanced SIG, of the NDP PPDU and Partial BW Info subfield in the EHT/EHT+NDPA frame. The beamformee may then prepare the beamforming feedback for the non-punctured 20 MHz subchannels of the requested 40 MHz feedback and may send it back to the beamformer.

According to one example embodiment, one of the reserved bits in the STA Info field in NDPA frame may be used to indicate that the Partial BW Info is intended for the upper or lower 160 MHz of a 320 MHz bandwidth or above. This bit may have a special meaning if the NDP PPDU bandwidth is 320 MHz. The Upper/Lower 160 MHz bit together with the resolution bit of the Partial BW Info subfield may allow for the support of 20 MHz sounding resolution in 320 MHZ bandwidth as indicated in Table 12 below.

In the case a beamformer may request a beamformee to measure CSI/CQI on subchannels from both upper and lower 160 MHz subchannels, the beamformer may include two STA Info fields on which the AID11 subfield may be set to the same value, i.e., based on the beamformee's AID. AID11 is a subfield defined in NDP Announcement (NDPA) frame to identify a STA. In one method, one reserved bit in STA Info field may be used to indicate that more than one STA Info fields are assigned for the beamformee so that the beamformee may continue decoding the NDPA frame even if it had decoded one STA Info field address to it.

TABLE 12
An Example Encoding of the Upper/Lower 160 MHz bit

| | Upper/Lower | Partial BW Info | |
|---|---|---|---|
| Bandwidth | 160 MHz bit | subfield | Meaning of the Partial BW Info subfield |
| 20, 40, 80, | reserved | 0XXXXXXXX | The requested subchannels indicated by the |
| 160 MHz | | | sequence XXXXXXXX is intended for the |
| | | | corresponding bandwidth (20, 40, 80, 160 MHz) |
| | | | and has a 20 MHz subchannel resolution |
| 320 | 0 | 0XXXXXXXX | The requested subchannels indicated by the |
| | | | sequence XXXXXXXX is intended for the lower |
| | | | 160 MHz and has a 20 MHz subchannel |
| | | | resolution |
| 320 | 1 | 0 XXXXXXXX | The requested subchannels indicated by the |
| | | | sequence XXXXXXXX is intended for the upper |
| | | | 160 MHz and has a 20 MHz subchannel |
| | | | resolution |
| 320 | 0 | 1 XXXXXXXX | The requested subchannels indicated by the |
| | | | sequence XXXXXXXX is intended for the entire |
| | | | 320 MHz and has a 40 MHz subchannel |
| | | | resolution |

In another embodiment, one of the reserved bits in the STA Info field may be designated as a Resolution subfield and used to indicate that the Partial BW Info subfield is either a bitmap with a 40 MHz subchannel resolution or a lookup table with a 20 MHz subchannel resolution. The Resolution subfield may have a meaning if the NDP PPDU bandwidth is 320 MHz. If the Resolution subfield is set=0, the Partial BW Info subfield for 320 MHz may be used as a bitmap such that the 9-bits may be set as “1XXXXXXXX” with the sequence “XXXXXXXX” referring to the requested subchannels with a 40 MHz resolution such that each bit “X” may refer to one 40 MHz subchannel in the 320 MHz channel bandwidth. If the Resolution subfield is set=1, the entire Partial BW Info subfield for 320 MHz may be used as a lookup table allowing for up to 512 different combination such that each combination maps to a designated set of requested subchannels with a resolution of 20 MHz subchannel in 320 MHz bandwidth. An example of the encoding of the Resolution subfield is indicated in Table 13 below.

TABLE 13
An Example of the Encoding of the Resolution Subfield

| | Resolution | Partial BW Info | |
|---|---|---|---|
| Bandwidth | subfield | subfield | Meaning of the Partial BW Info subfield |
| 20, 40, 80, | reserved | 0XXXXXXXX | The requested subchannels indicated by the |
| 160 MHz | | | sequence XXXXXXXX is intended for the |
| | | | corresponding bandwidth (20, 40, 80, 160 |
| | | | MHz) and has a 20 MHz subchannel resolution |
| 320 | 0 | 1XXXXXXXX | The requested subchannels indicated by the |
| | | | sequence XXXXXXXX is intended for the |
| | | | entire 320 MHz and has a 40 MHz subchannel |
| | | | resolution |
| 320 | 1 | XXXXXXXXX | The requested subchannels indicated by the |
| | | | sequence XXXXXXXXX provides an entry |
| | | | for a lookup table such that each entry may |
| | | | map to a set of requested subchannels in |
| | | | 320 MHz bandwidth with a 20 MHz resolution |

In certain embodiments, assuming additional/dynamic puncturing occurs, i.e., subchannels punctured other than indicated by the Disabled Subchannel Bitmap at the sounding TXOP, one bit in the NDPA frame or one bit in the SIG field of the PPDU carrying NDPA frame may be used to indicate that the U-SIG field, or enhanced SIG field, of the following NDP PPDU may use an OFDMA puncturing pattern, and the U-SIG, or enhanced SIG, field may vary from one 80 MHz subchannel to another 80 MHz subchannel. An intended Beamformee STA may use entire the bandwidth indicated by the NDPA frame to perform preamble detection of the NDP PPDU if the STA supports that bandwidth. An intended Beamformee STA may use the largest bandwidth it supports to perform preamble detection of the NDP PPDU if the STA is not capable to support the bandwidth indicated in the NDPA frame.

For example, the NDPA frame is transmitted using a non-HT dup PPDU over 160 MHz bandwidth. The beamformer may identify a 20 MHz subchannel in the primary 80 MHz subchannel is indicated as disabled in the Disabled Subchannel Bitmap, and a 20 MHz subchannel in the secondary 80 MHz subchannel is not available for transmission due to some reason such as channel sensing results. The beamformer may use the bit in NDPA frame or the PPDU carrying NDPA frame to indicate the U-SIG field of the following NDP PPDU may use OFDMA puncturing pattern. Beamformee1 may be able to detect signal over 160 MHz channel. On reception of the bit in NDPA transmission, beamformee1 may open the entire 160 MHz bandwidth to detect the NDP PPDU. In the U-SIG field carried over the primary 80 MHz subchannel, beamformee1 may notice one 20 MHz subchannel is punctured, and in the U-SIG field carried over the secondary 80 MHz subchannel, beamformee1 may notice one 20 MHz subchannel is punctured. The RXVECTOR parameter INACTIVE_SUBCHANNELS of beamformee1 may have both 20 MHz subchannels included (not punctured). In this case, beamformee1 may puncture both 20 Mhz subchannels in the transmissions in the rest of the TXOP. Beamformee2 may be able to detect the signal over an 80 MHz channel. On reception of the bit in the NDPA transmission, beamformee2 may open the entire 80 MHz bandwidth to detect the NDP PPDU. Beamformee2 may notice the punctured subchannel over the primary 80 MHz. This is not a problem because beamformee2 transmits/receives only on the primary 80 MHz channel.

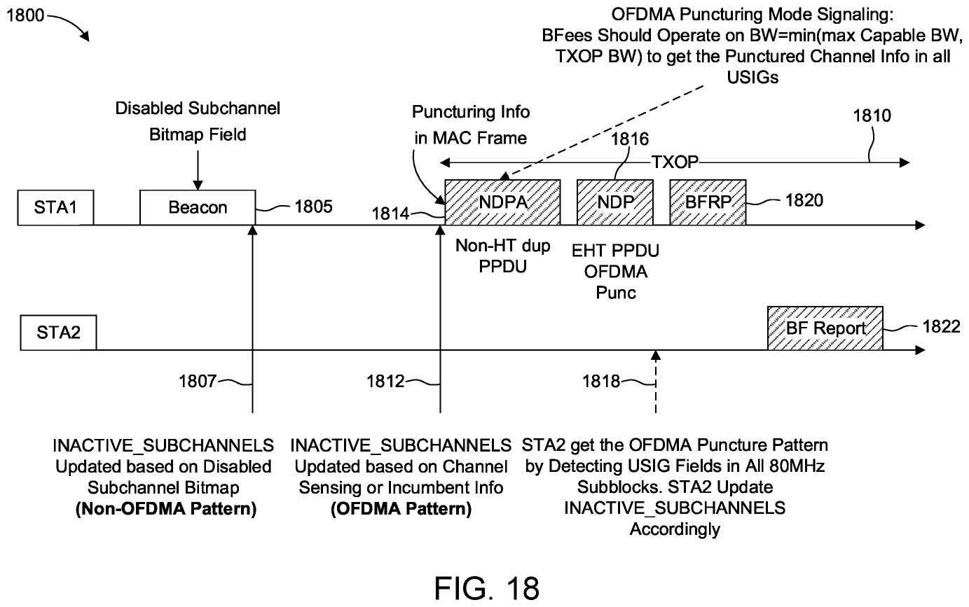

FIG. 18 illustrates a method 1800 for communicating in a wireless network using a sounding procedure including an OFDMA puncturing pattern for beamforming according to an exemplary embodiment.

As shown in FIG. 18, at 1818, a beamformee (e.g., STA2) may combine punctured subchannel information carried in Partial BW field in NDPA frame 1814 and Punctured Channel Information field in U-SIG field, or enhanced SIG field, in the subsequent NDP PPDU 1816 to determine the requested RU/MRU or subchannel for measurement, e.g., requested in NDPA frame 1814. In other words, the Partial BW field in the NDPA frame 1814 may have resolution of 20 MHz or 40 MHz, depending on the sounding bandwidth. At 1818, STA2 may use the Partial BW field in the NDPA frame to determine the RU/MRU on which it may need to measure the CSI and/or CQI. STA2 may then check the punctured subchannels in U-SIG field, or enhanced SIG field in the subsequent NDP PPDU, if the requested RU/MRU is further punctured, then STA2 may measure CSI and/or CQI on the non-punctured portion of the RU/MRU. In the beamforming feedback frame 1822, the beamformee STA2 may transmit a report 1822 including a MIMO Control field with Partial BW field set to the same value as that in NDPA frame 1814. In addition, one reserved bit in MIMO control field may be used to indicate that punctured channel information carried in U-SIG field of the NDP frame 1816 may be used to help determine the non-punctured portion of the RU/MRU to be measured and reported in BFR 1822.

As before, the Disabled Subchannel Bitmap field may be carried in a management frame, such as Beacon frame 1805, and transmitted by an AP or potentially, a non-AP STA. In one method, the Disabled Subchannel Bitmap field may use a non-OFDMA puncture pattern at 1807. STAs receiving the beacon 1805, may set their TXVECTOR parameter INACTIVE_SUBCHANNELS of an HE, EHT, EHT+, or non-HT duplicate PPDU based on the Disabled Subchannel Bitmap field.

STA1 (a beamformer, e.g., an AP or a non-AP STA) may acquire the channel and begin a sounding TXOP 1810. STA1 may update the TXVECTOR parameter INACTIVE_SUBCHANNELS of an HE, EHT, EHT+, or non-HT duplicate PPDU to include the additional subchannels other than that indicated in the Disabled Subchannel Bitmap field. In one method, STA1 may determine to use OFDMA puncture patterns to signal the inactive subchannels 1812.

STA1 may transmit a null data packet announcement (NDPA) frame 1814 which may be carried in a non-HT duplicate PPDU. One-bit or other indication in NDPA frame, or in the SIG field of the PPDU carrying NDPA frame, may be used to indicate that a U-SIG field of the following NDP PPDU 1816 may use an OFDMA puncturing pattern and the U-SIG field may vary from one 80 MHz subchannel to another 80 MHz subchannel. This bit may be denoted as a Puncturing Mode field (or other name such as Wideband Operation Mode Indication, etc.). On reception of the NDPA frame, STA2 (a beamformee) may prepare to receive the NDP frame using a bandwidth, which is the minimum value of the TXOP operating bandwidth accounted in the NDPA frame, and the its maximum supported bandwidth. As used herein, this bandwidth may be denoted as BW_full.

STA1 may transmit a NDP PPDU 1816 which may be an EHT MU PPDU or EHT+PPDU and an OFDMA puncturing pattern may be used to signal which subchannels may be punctured in the NDP PPDU transmission 1816. At stage 1818, STA2 may need to decode the entire NDP PPDU using the above-mentioned bandwidth (i.e., BW_full) so that it may decode U-SIG fields on all decodable 80 MHz subblocks. In theory, subcarriers that may be punctured may be identified in Disabled Subchannel Bitmap of management frame 1805 (i.e., static puncturing) and additional or dynamic puncturing may be implemented at stage 1812 by the beamformer, and even by the beamformee (e.g., STA2) when measuring and providing feedback in BFR 1822. At stage 1818, STA2 may identify dynamic puncturing by STA1 based on NDPA 1814 and NDP 1816 and update its INACTIVE_SUBCHANNELS parameter accordingly.

To allow NDP PPDU 1816 to use an OFDMA puncturing pattern, one or more embodiments discussed below may be adopted. In one embodiment, the PPDU Type And Compression Mode subfield in U-SIG field is set=3 (indicating the NDP PPDU is transmitted with OFDMA puncturing pattern), the EHT-SIG MCS field is set=0 and the Number Of EHT-SIG Symbols field is set=0 to indicate a sounding NDP with OFDMA puncturing pattern. In this way, the table of combination of UL/DL and PPDU Type And Compression Mode field may be modified as shown in Table 14 below. When the PPDU Type And Compression Mode subfield is set=3, the Punctured Channel Information subfield in the U-SIG field may indicate an OFDMA puncturing pattern.

TABLE 14
Modifications of combination of UL/DL and PPDU TRype and Compression Mode Fields

| | | Description | | | | |
|---|---|---|---|---|---|---|
| U-SIG fields | | | | | Total number | |
| | PPDU | | | RU | of User fields | |
| | Type And | EHT | | Allocation | in MU PPDU | |
| | Compression | PPDU | EHT-SIG | subfields | or transmitters | |
| UL/DL | Mode | format | present? | present? | inTB PPDU | Note |
| 0(DL) | 0 | EHT MU | Yes | Yes | □ 1 | DL OFDMA |
| | | | | | | (including non- |
| | | | | | | MU-MIMO and |
| | | | | | | MU-MIMO) |
| | 1 | EHT MU | Yes | No | 1 for | Transmission to a |
| | | | | | transmission | singleuser or NDP |
| | | | | | to asingle | (Not to AP, Typically |
| | | | | | user; 0 for | “DL”) |
| | | | | | NDP | |
| | 2 | EHT MU | Yes | No | >1 | DL MU-MIMO |
| | | | | | | (non-OFDMA) |
| | 3 | EHT MU | Yes | Yes or No | 0 for NDP; | NDP with OFDMA |
| | | | | | otherwise | puncture patterns or |
| | | | | | reserved | other new type of |
| | | | | | | PPDU |

Description

| U-SIG fields | | | | | Total number | |
|---|---|---|---|---|---|---|
| | PPDU Type | | | RU | ofUser fields | |
| | And | EHT | | Allocation | in MU PPDU | |
| | Compression | PPDU | EHT-SIG | subfields | or transmitters | |
| UL/DL | Mode | format | present? | present? | in TB PPDU | Note |
| 1 (UL) | 0 | EHT TB | No | — | □ 1 | UL OFDMA orUL |
| | | | | | | non-OFDMA |
| | | | | | | (including non- |
| | | | | | | MU-MIMO and |
| | | | | | | MU- MIMO) |
| | 1 | EHT MU | Yes | No | 1 for | Transmission to a |
| | | | | | transmission | singleuser or NDP |
| | | | | | to asingle | (To AP, i.e., |
| | | | | | user; 0 for | “UL”) |
| | | | | | NDP | |
| | 2 | EHT MU | Yes | Yes or No | 0, and/or 1 for | Transmission to one |
| | | | | | transmission | or more AP using |
| | | | | | to a single | OFMDA puncturing |
| | | | | | AP; and/or >1 | pattern |
| | | | | | for MAP | |
| | 3 | EHT MU | Yes | Yes or No | 0 for NDP; | NDP with OFDMA |
| | | | | | otherwise | puncture patterns or |
| | | | | | reserved | other new type of |
| | | | | | | PPDU |

Alternatively, when the PPDU Type And Compression Mode field is set=0, the EHT-SIG MCS field is set=0 and the Number Of EHT-SIG Symbols field is set=0, a sounding NDP with OFDMA puncturing pattern is signaled.

After the NDP 1816, STA1 may transmit a beamforming report poll (BFRP) 1820 triggering beamformees, e.g., STA2 to feedback measured characteristics of the channel in a beamforming report (BFR) 1822. Other trigger frames may be sent by STA1 and responded to by STA2 not limited to the BFRP and BFR. In response to BFRP 1820, STA2 measures/determines CSI feedback for its BFR. It is noted that because STA2 can obtain the OFDMA puncture pattern by detecting 1818 USIG, or enhanced SIG, fields in all 80 MHz subblocks, it may update the INACTIVE_SUBCHANNELS parameter and limit feedback measurements to non-punctured subchannels in BFR 1822. Moreover, STA2 itself may determine to dynamically puncture subchannels, e.g., based on sensing or energy detection. All punctured subchannels are included in its INACTIVE_SUBCHANNEL parameter and the puncturing may be signaled back to STA1, e.g., in BFR 1822.

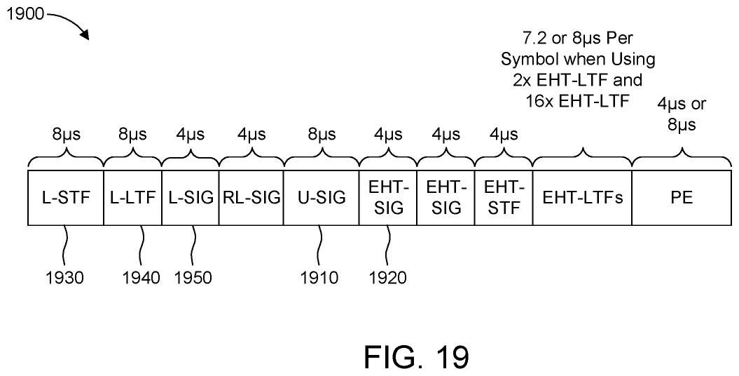

The sounding NDP PPDU format with OFDMA puncture pattern may enhance an established NDP PPDU format 1900, as shown in FIG. 19. Punctured Channel Info subfield in U-SIG 1910 may indicate OFDMA puncturing patterns or other puncture patterns which may include more valid patterns than established non-OFDMA puncturing patterns. RU allocation subfield may not present in the EHT-SIG field 1920. Note, the U-SIG field 1910 may be the same for every 20 MHz subchannel within an 80 MHz subblock. However, it may be different for different 80 MHz subblocks since the Punctured Channel Info subfield may be provided per-80 MHz signaling.

To support a sounding procedure with OFDMA puncture patterns in method 1800 of FIG. 18, NDPA frame 1814 may be modified or enhanced. A Puncture Pattern Mode subfield of the type previously discussed, may be carried in STA Info field in NDPA frame 1814. When this subfield is set, beamformees may need to prepare for the reception of NDP frame 1816 (including the pre-EHT portion) using BW_full. A Full Puncture Channel Info subfield may be included to carry full puncture channel information and the subfield may be, for example, 12-16 bits long. In one method, the subfield may be carried in a special STA Info field which may be identified by a special AID. In one method, this special AID is different from any special AID used in 802.1 lax.

When the Puncture Pattern Mode subfield is set to indicate OFDMA puncture patterns, the Partial BW subfield may have new meaning(s). In one example embodiment, the existing 9-bit Partial BW subfield and some reserved bits may be used together to indicate the requested subchannels or RU/MRUs on which the sounding feedback may be measured. In one embodiment, this signaling may correspond to a look-up table resident in a device (e.g., STA2). In another embodiment, the first bit of the Partial BW subfield may be used to indicate the 160 MHz subchannel of the requested sounding feedback. If the total bandwidth of the NDPA transmission is 320 MHz, two STA Info fields with the same AID may be used to carry information for a single beamformee and each STA Info field may correspond to a specific 160 MHz subchannel. In other embodiments, the Partial BW subfield may follow the existing signaling method. The beamformee may measure based on subchannels/RU/MRU indicated in Partial BW subfield except the punctured subchannels indicated in U-SIG fields of the NDP PPDU 1816.

In other embodiments of method 1800 including sounding procedure with OFDMA puncture patterns, a STA may indicate its capability to support the sounding procedure with OFDMA puncturing or wideband reception for pre-EHT or pre-Enhanced part of an EHT or an Enhanced PPDU of various embodiments. As shown in FIG. 19, the pre-Enhanced part of the Enhanced PPDU 1900 may include L-STF field 1930, L-LTF field 1940, L-SIG field 1950, and the Enhanced-SIG field(s). When this capability bit is set, the STA may be able to decode the pre-EHT or pre-Enhanced part of an EHT or Enhanced PPDU and EHT or Enhanced part of the PPDU using the same bandwidth. Further, the STA may be able to decode 1818 OFDMA puncture patterns carried in U-SIG fields in more than one 80 MHz subblock.

As used herein, the term OFDMA puncture pattern is not limiting and may be generalized to include any puncture patterns which may include more puncture patterns than the non-OFDMA puncturing patterns or static puncture patterns.

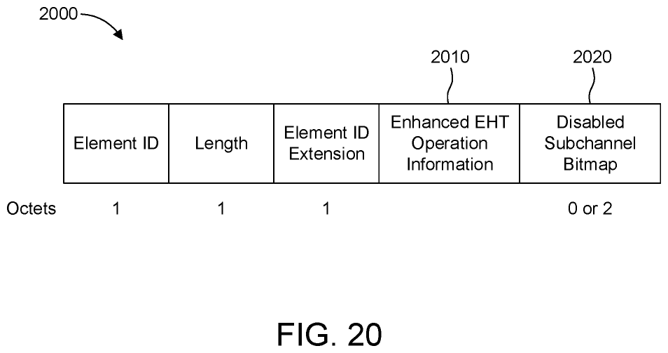

Referring to FIG. 20, an example embodiment for EHT Operation element 2000 is shown. In this example, one subfield (e.g., referred to as the Disabled Subchannel Puncturing Pattern) in the Enhanced EHT Operation Information field 2010 may be used along with the Disabled Subchannel Bitmap field 2020 used for the non-OFDMA and/or OFDMA puncturing patterns in embodiments discussed earlier. For example, when the Disabled Subchannel Bitmap Present subfield 2020 and the Enhanced EHT Operation Information field 2010 is set to 1, the Disabled Subchannel Puncturing Pattern subfield in the Enhanced EHT Operation Information field may contain one bit to indicate the Disabled Subchannel Bitmap follows OFDMA puncturing patterns or non-OFDMA puncturing patterns. The OFDMA puncturing patterns may follow one type of puncturing pattern. The puncturing pattern may be: every 4 bits represent one 80 MHz channel. For example, this 4-bit bitmap is indexed by the 20 MHz subchannels in ascending order. For each bit, a value of 0 indicates the corresponding 20 MHz subchannel is punctured, and a value of 1 is used otherwise. The puncturing pattern is defined for an 80 MHz subblock, e.g., 1111 (no puncturing), 0111, 1011, 1101, 1110, 0011, 1100 and 1001; or every 8 bits represent one 160 MHz channel. For example, this 8-bit bitmap is indexed by the 20 Mhz subchannels in ascending order. For each bit, a value of 0 indicates the corresponding 20 MHz channel is punctured, and a value of 1 is used otherwise. The puncturing pattern of each 160 MHz may follow the puncturing patterns defined in the non-OFDMA transmission with 160 MHz channel or some newly defined puncturing patterns.

Alternatively, the Disabled Subchannel Puncturing Pattern subfield in the Enhanced EHT Operation Information field 2010 may contain more than 1 bit (e.g., 2-bits) to indicate if the puncturing pattern in the Disabled Subchannel Bitmap field uses the non-OFDMA puncturing pattern, or the puncturing pattern in the Disabled Subchannel Bitmap field uses the 80 MHz non-OFDMA puncturing pattern (which means every 4-bits represents the bitmap of 80 MHz channel) or the puncturing pattern in the Disabled Subchannel Bitmap field 2010 uses the 160 MHz non-OFDMA puncturing pattern (which means every 8-bits represents the bitmap of 160 MHz channel). Alternatively, an additional subfield is not needed to indicate if the puncturing patterns of Disabled Subchannel Bitmap 2020 uses the non-OFDMA or OFDMA puncturing pattern. The puncturing patterns of Disabled Subchannel Bitmap 2020 just indicates the OFDMA puncturing pattern, e.g., uses the 80 MHz OFDMA puncturing pattern (which means every 4-bits represents the bitmap of the 80 MHz channel) or the 160 MHz OFDMA puncturing pattern (which means every 8-bits represents the bitmap of 160 MHz channel).

Table 15 below depicts example definitions and encoding of the Disabled Subchannel Puncturing Pattern subfield in Enhanced EHT Operation Information field.

TABLE 15
Disabled Subchannel Puncturing Pattern Subfield
in Enhanced EHT Operation Information Field

| Subfield | Definition | Encoding |
|---|---|---|
| Disabled | This subfield indicates what | 0: non-OFDMA puncturing |
| Subchannel | puncturing pattern the | patterns |
| Puncturing | Disabled Subchannel Bitmap | 1: OFDMA puncturing patterns |
| Pattern | field may follow when the | (one type of puncturing pattern, |
| | Disable Subchannel Bitmap | e.g., every 4-bit bitmap represent |
| | Present subfield is present | every 80 MHz subblock |
| | | puncturing pattern, or every 8-bit |
| | | bitmap represents every 160 MHz |
| | | channel puncturing patter) |
| | | Or |
| | | 0: non-OFDMA puncturing |
| | | patterns |
| | | 1: OFDMA puncturing patterns, |
| | | i.e., every 4-bit bitmap in the |
| | | Disabled Subchannel Bitmap |
| | | field follows the 80 MHz |
| | | puncturing patterns |
| | | 2: OFDMA puncturing patterns, |
| | | i.e., every 8-bit bitmap in the |
| | | Disabled Subchannel Bitmap |
| | | field follows the 160 MHz |
| | | puncturing patterns |

The terminology and corresponding procedures discussed herein may be extended for other future generation of 802.11 amendments or related systems. The term “preamble puncturing” may refer to a general puncturing case which may be static puncturing, dynamic puncturing, or static and dynamic puncturing. The term “dynamic puncturing” and “additional puncturing” may be used interchangeably.

Although the terminology “upper or lower 160 MHz,” or similar, is used above, the methods disclosed can be applied to “primary/secondary 160 MHz.” This can be done by replacing “upper or lower 160 MHz” with “primary or secondary 160 MHz”; replacing “lower 160 MHz” with “primary 160 MHz” or “secondary 160 MHz”; replacing “upper 160 MHz” with “secondary 160 MHz” or “primary 160 MHz”. Further, methods disclosed in different embodiments may be used together.

Although the features and elements of the present invention are described in the preferred embodiments in particular combinations, each feature or element may be used alone without the other features and elements of the preferred embodiments or in various combinations with or without other features and elements of the present invention. Although the solutions described herein consider 802.11 specific protocols, it is understood that the solutions described herein are not restricted to this scenario and are applicable to other wireless systems as well. Although SIFS is used to indicate various inter frame spacing in the examples of the designs and procedures, all other inter frame spacing such as RIFS, AIFS, DIFS or other agreed time interval could be applied in the same solutions. Although four RBs per triggered TXOP are shown in some figures as example, the actual number of RBs/channels/bandwidth utilized may vary. Although specific bits are used to signal in-BSS/OBSS as example, other bit may be used to signal this information. Although some Trigger Type values are used as examples to identify the newly defined trigger frame variants, other values may be used. Multi-AP and MAP are used interchangeably to refer to the same concept. Long Training Field (LTF) may be any type of predefined sequences that are known at both transmitter and receiver sides.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a first station (STA1), the method comprising:
receiving a null data packet announcement (NDPA) frame, the NDPA frame including an indicator of orthogonal frequency division multiple access (OFDMA) subchannel puncturing of a subsequent null data packet (NDP);
receiving the NDP, the NDP occupying at least one 80 MHz channel, the NDP including a U-SIG field indicating an OFDMA puncturing pattern; and
transmitting a beamforming report (BFR) to a second station (STA2), the BFR including measurement information associated with subchannels that are present in the NDP based on the OFDMA puncturing pattern.

2. The method of claim 1, wherein the NDPA frame includes indicia of inactive subchannels in a partial bandwidth (BW) subfield.

3. The method of claim 1, wherein the OFDMA puncturing pattern indicates OFDMA subcarriers that are not used in the NDP.

4. The method of claim 1, wherein the NDPA frame comprises a duplicate non-high throughput (Non-HT) physical protocol data unit (PPDU) having a partial BW subfield containing the indicia of the OFDMA subchannel puncturing with 40 MHz minimum subchannel resolution, and wherein the NDP comprises an extremely high throughput (EHT) PPDU including the U-SIG field having the OFDMA puncturing pattern with 20 MHz minimum subchannel resolution.

5. The method of claim 1, wherein the STA2 comprises an access point and wherein the method further comprises:
receiving a beamforming report poll (BFRP) soliciting the BFR.

6. The method of claim 1, wherein the indicator of OFDMA subchannel puncturing comprises an OFDMA puncturing mode signal indicating a higher resolution of subchannel puncturing in the NDP.

7. The method of claim 1, wherein the measurement information excludes punctured subchannels identified in a disabled subchannel bitmap.

8. A station (STA1) comprising:
a transceiver; and
a processor in communication with the transceiver, the processor and transceiver configured to:
receive a null data packet announcement (NDPA) frame, the NDPA frame including an indicator of orthogonal frequency division multiple access (OFDMA) subchannel puncturing of a subsequent null data packet (NDP);
receive the NDP occupying at least one 80 MHz channel, the NDP including a U-SIG field indicating an OFDMA puncturing pattern; and
transmit a beamforming report (BFR) to a second station (STA2), the BFR including measurement information associated with subchannels that are present in the NDP based on with the OFDMA puncturing pattern.

9. The STA1 of claim 8, wherein the NDPA frame includes indicia of inactive subchannels in a partial bandwidth (BW) subfield.

10. The STA1 of claim 8, wherein the OFDMA puncturing pattern indicates OFDMA subcarriers that are not used in the NDP

11. The STA1 of claim 8, wherein the NDPA frame comprises a duplicate non-high throughput (Non-HT) physical protocol data unit (PPDU) having a partial BW subfield containing the indicator of the OFDMA subchannel puncturing with 40 MHz minimum subchannel resolution, and wherein the NDP comprises an extremely high throughput (EHT) PPDU including the U-SIG having the OFDMA puncturing pattern with 20 MHz minimum subchannel resolution.

12. The STA1 of claim 8, wherein the STA2 comprises an access point and wherein the processor and transceiver are further configured to:
receive a beamforming report poll (BFRP) soliciting the BFR.

13. The STA1 of claim 8, wherein the indicator of OFDMA subchannel puncturing comprising an OFDMA puncturing mode signal indicating a higher resolution of subchannel puncturing in the NDP.

14. The STA1 of claim 8, the measurement information associated with subchannels that are not punctured in accordance with the OFDMA puncturing pattern further excludes punctured subchannels identified in a disabled subchannel bitmap.

15. An access point (AP) comprising:
a transceiver; and
a processor in communication with the transceiver, the processor and transceiver configured to:
transmit a null data packet announcement (NDPA) frame, the NDPA frame including an indicator of an orthogonal frequency division multiple access (OFDMA) subchannel puncturing of a subsequent null data packet (NDP);
transmit the null data packet (NDP) occupying at least one 80 MHz channel, the NDP including a U-SIG field indicating an OFDMA puncturing pattern;
transmit a beamforming report poll (BFRP), to a first station (STA1) soliciting a beamforming report (BFR); and
receive the BFR from the STA1 in response to the BFRP, the BFR including measurement information associated with subchannels that are not punctured based on the OFDMA puncturing pattern.

16. The AP of claim 15 wherein the NDPA frame includes indicia of inactive subchannels in a partial bandwidth (BW) subfield.

17. The AP of claim 15 wherein the NDPA frame comprises a duplicate non-high throughput (Non-HT) physical protocol data unit (PPDU) having a partial BW subfield containing the indicator of the OFDMA subchannel puncturing with 40 MHz minimum subchannel resolution, and wherein the NDP comprises an extremely high throughput (EHT) PPDU including the U-SIG having the OFDMA puncturing pattern with 20 MHz minimum subchannel resolution.

18. The AP of claim 15 wherein the indicator of OFDMA subchannel puncturing comprising an OFDMA puncturing mode signal.

19. The AP of claim 15 wherein the processor and transceiver are further configured to transmit a beacon including indicia of punctured subchannels in a disabled subchannel bitmap field.

20. The AP of claim 19 wherein the measurement information associated with subchannels that are not punctured further excludes punctured subchannels identified in the disabled subchannel bitmap field.
